(19) United States
(12) Patent Application Publication
(10) Pub. No.: US 2016/0029100 A1
(43) Pub. Date: Jan. 28, 2016

(54) MULTI-DIMENSIONAL SOUND SYSTEM FOR USE WITH AN INTERACTIVE DEVICE

(71) Applicant: Suzo-Happ Group, Mount Prospect, IL (US)

(72) Inventors: Darren W. White, Mount Prospect, IL (US); Michael Gardner, Mount Prospect, IL (US); Jeffrey Beu, Mount Prospect, IL (US); Robert Tenney, Mount Prospect, IL (US); Ian Dominicis, Mount Prospect, IL (US); Peter Wright, Mount Prospect, IL (US); Ryan Harris, Mount Prospect, IL (US)

(73) Assignee: Suzo-Happ Group, Mount Prospect, IL (US)

(21) Appl. No.: 14/810,884

(22) Filed: Jul. 28, 2015

Related U.S. Application Data
(60) Provisional application No. 62/029,720, filed on Jul. 28, 2014.

(51) Int. Cl. H04N 21/485; H04N 21/439; H04N 21/436; H04N 21/422

(52) U.S. Cl. CPC H04N 21/4852; H04N 21/42224; H04N 21/439; H04N 21/43615

(57) ABSTRACT

A multidimensional sound system coordinates the playback of audio streams on a device that outputs more than one video stream simultaneously. The system provides a method for splitting and directing sound so that multiple users viewing multiple content streams on a single device can hear audio relevant to the video content they wish to view. The system also provides methods directed to allowing users to share audio relevant to their respective video streams with other users on the same device, and allows users to reject such sharing requests.

### CROSS-REFERENCE TO RELATED APPLICATIONS

This Application claims priority to U.S. Patent Application No. 62/029,720, filed Jul. 28, 2014, entitled MULTI-DIMENSIONAL SOUND SYSTEM FOR USE WITH AN INTERACTIVE DEVICE, which is hereby incorporated by reference in its entirety.

### FIELD OF THE INVENTION

The present invention relates to content management systems, methods, apparatus and user interfaces. In particular, the present invention relates to systems, methods, apparatus and user interfaces for transmitting, displaying and enabling the manipulation of content from multiple sources.

### BACKGROUND OF THE INVENTION

In public spaces devoted to sporting events, like sports bars or sports books, it is often the case that people present may want to watch more than one of the many events broadcasted and ongoing at a particular time. Several solutions exist for this problem, including using multiple televisions spaced throughout an area or using a large television with the well-known picture-in-picture feature to display multiple video streams from one or more “set top” cable or satellite television boxes. More novel and innovative systems for displaying multiple content streams to multiple users also exist. One such device is disclosed in U.S. patent application Ser. No. 14/347,926. This device may be embodied in a large gaming table designed to display more than one video content stream to users standing around the device.

One difficulty inherent in displaying multiple video streams relates to allowing users to listen to the audio associated with those video streams. Prior art solutions include prioritizing the audio for one video stream over the audio for other video streams, causing some users to not hear their desired audio. Other prior art includes providing personalized audio devices such as headphones to users, which reduces the social aspect of being in a public space. Still another prior art solution involves simply broadcasting all audio streams risking unwanted noise pollution from hearing unwanted audio. There exists a need for a system and method for managing the broadcasting of audio streams in a multi-dimensional fashion to allow for users viewing a specific video stream to hear audio associated with that video stream without the drawbacks of the prior art systems described above.

### SUMMARY OF THE INVENTION

The present invention is directed to systems and methods for managing content from multiple sources. Specifically, the invention is directed to a multidimensional sound system that coordinates the playback of audio streams on a device that outputs more than one video stream simultaneously. The invention provides a method for splitting and directing sound so that multiple users viewing multiple content streams on a single device can hear audio relevant to the video content they wish to view. The invention also provides methods directed to allowing users to share audio relevant to their respective video streams with other users on the same device, and allows users to reject such sharing requests.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is a schematic diagram of a system for managing content supplied from a plurality of sources in accordance with embodiments of the present invention;

FIG. 2 is a schematic diagram illustrating embodiments of the system, method and apparatus of the present invention; FIG. 3 is a schematic diagram illustrating a graphical user interface according to embodiments of the present invention;

FIG. 3A is a schematic diagram illustrating a graphical user interface according to other embodiments of the present invention; and

FIG. 4 is a general flow diagram illustrating methods according to embodiments of the present invention.

FIGS. 5A-5F are block diagrams illustrating a sound system for manipulating the sound output to multiple sound devices based on orientation of the content being displayed.

FIGS. 6A-6D are diagrams illustrating a plurality of preset display configurations according to an embodiment of the present invention.

FIGS. 7A-8B are diagrams illustrated different display and audio configurations, according to an embodiment of the present invention.

FIGS. 9A-19AV are diagrams illustrating different display and audio configuration, according to another embodiment of the present invention.

FIGS. 20A-20F are diagrams illustrating a portion of a user interface that allows user(s) to select a configuration from a plurality of predetermined configurations.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Embodiments of the present invention will be described with reference to systems, methods, apparatus and user interfaces for transmitting, displaying and enabling the manipulation of content from multiple sources which enable multiple channels from different sources to be viewed simultaneously and which enable switching between channels with at least reduced, if not negligible latency compared with the prior art. Additionally, a multi-dimensional sound system which allows the sound, e.g., the signal being output or transmitted through various speakers and/or sound levels to be configured.

In this specification, references will be made to communications between various elements via one or more communications networks. In some embodiments, the communications network is the Internet. However, the present invention is not limited to communications via the Internet and the use of other communications networks is envisaged, such as, but not limited to one or more of public communications networks, private communications networks, local area networks (LANs), wide area networks (WANs), management area networks (MANs), intranets, extranets or any combination thereof as are known to the skilled addressee and which can be implemented via known wired and/or wireless communication means.

It should also be appreciated that in this specification, references to content refer to any type of content, such as, but not limited to audio, video, still images, text, graphics or any combination thereof. Consequently, references herein to displaying content include the playing of audio.

As discussed further below, the present invention is directed towards a multi-dimensional sound system configured to be used with a display structure or device such as a table or other structure having a surface. The display structure may include one or more touchscreen displays configured to display/play audio/visual content. The visual content or portion may be displayed in one or more moveable/configurable display areas or windows displayed on the touchscreen display(s). In general, the content being displayed may be managed, configured, and/or manipulated using a content management system. In one aspect of the invention, the audio/video content may be received and/or generated from multiple sources. An exemplary system for managing, configuring, and/or manipulating content is described in the next section. However, it should be noted that the present invention is not limited to any such system.

### Examplary System Architecture

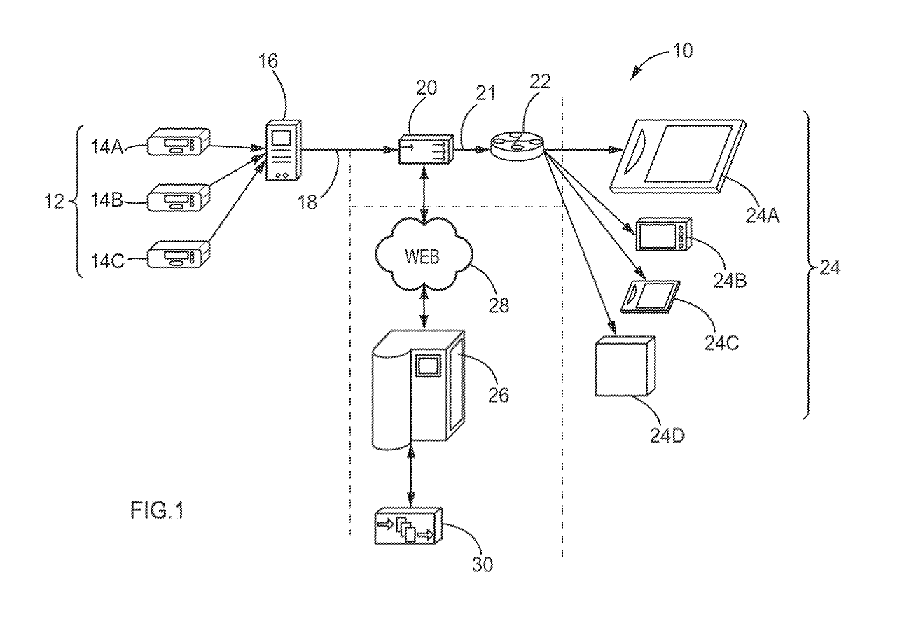

With reference to FIG. 1 and in accordance with one aspect, embodiments of the present invention reside in a system 10 for managing content supplied from a plurality of sources 12, such as, but not limited to free to air television, video on demand (VOD), satellite television, cable television, in-house television, radio channels, web browser content, such as content from a specific website and static content, for example, from a specific file, content generated locally or remotely, and/or content generated by a software application, such as a game, that is being run locally or remotely. The present application may be used to manage content from any type of source, either remote or locally, e.g., an audio/video file could be located remotely or locally. A dedicated receiver 14A, 14B, 14C, such as a “set top box,” is required to receive each respective signal from the plurality of sources 12.

As in conventional systems, signals from the receivers 14A, 14B, 14C are received by a modulator 16, for example at the venue, which combines the multiple signals into a modulated signal 18. The modulated RF signal 18 comprising the multiple signals is transmitted to a server 20, such as an IPTV server. If required, the server 20 transcodes one or more of the signals, for example, from MPEG2 format to MPEG4 format as is known in the art. The server 20 can also resize content to suit the final output. Both transcoding and resizing reduce the amount of data and thus the bandwidth required. The server 20 combines the signals into a multicast stream 21 and transmits the multicast stream comprising streams representing the signals from the plurality of sources, typically via one or more routers 22.

The system 10 includes one or more apparatus 24 coupled to be in communication with the server 20. Each apparatus subscribes to and receives the multicast stream 21 transmitted by the server 20. As described in further detail hereinafter, each apparatus 24 includes a plurality of player objects and at least one viewing object. Each player object is paired with a constituent stream of the multicast stream 21. The at least one viewing object is coupled with one of the player objects to display content from the stream paired with the respective player object.

As will be described in further detail hereinafter, apparatus 24 can be in the form of a tabletop display 24A, a bar top or desk top display 24B, a display tablet 24C or a conventional IPTV receiver 24D.

Whilst the modulator 16 and server 20 are shown as separate elements in FIG. 1, according to some embodiments, the modulator 16 and server 20 can be incorporated in apparatus 24.

According to some embodiments, the system 10 includes a master control server 26 coupled to be in communication with the server 20 via a communications network 28, such as, but not limited to the Internet.

According to some embodiments, the system 10 includes a content management module 30 coupled to be in communication with the server 20, preferably via the master control server 26, to provide additional content to the apparatus 24. In some embodiments, the additional content can relate to the venue in which embodiments of the present invention is implemented, such as information relating to goods and/or services provided in the venue.

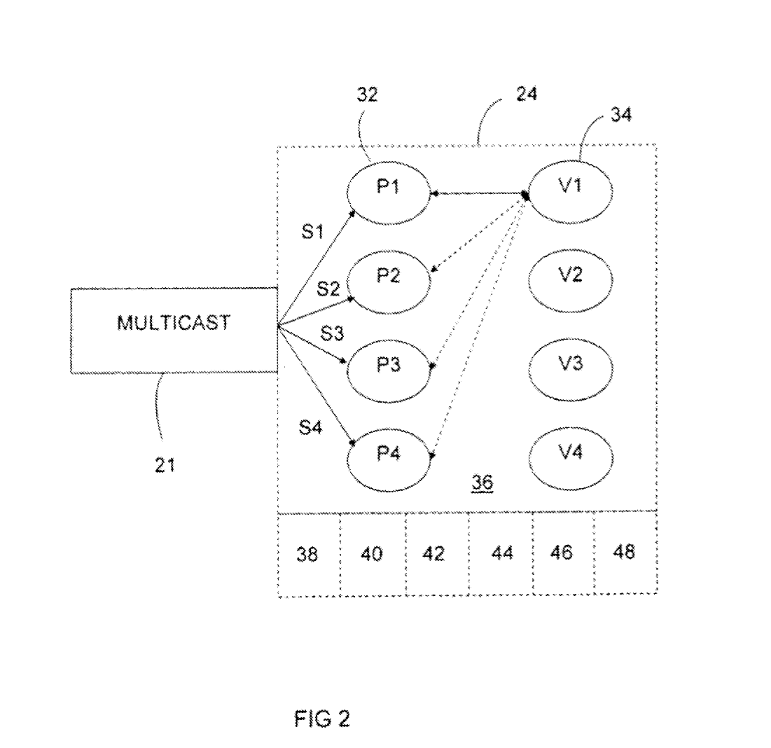

With reference to FIG. 2, and in accordance with another aspect, embodiments of the present invention reside in an apparatus 24 for managing content supplied from a plurality of sources in a multicast stream 21. Apparatus 24 includes a plurality of player objects 32 implemented in software. Each player object 32 is paired with a constituent stream of the multicast stream 21. In the example shown in FIG. 2, apparatus 24 comprises four player objects 32 in the form of player objects P1, P2, P3 and P4 each linked with a respective stream SI, S2, S3, and S4 of the multicast stream 21.

Apparatus 24 includes at least one viewing object 34 implemented in software coupled with one of the player objects 32 to display content from the stream paired with the respective player object. In the example shown in FIG. 2, apparatus 24 includes four viewing objects 34 in the form of viewing objects V1, V2, V3 and V4. Viewing object V1 is coupled with player object P1 to display content from stream S1 paired with player object P.

To switch the stream displayed by the viewing object V1, the viewing object VI is coupled with a different player object, such as P2, P3 or P4, to display the respective streams S2, S3, or S4 paired with the respective player object. In doing so, viewing object V I is decoupled from playing object P1.

Player objects 32 act as a pseudo channel or proxy between the server 20 and the viewing object 34 with which the player object is coupled. Player objects 32 manage the view of the stream content and are independent of the viewing area in use by the apparatus 24. Viewing objects 34 manage parameters concerned with displaying the content and switching between streams (e.g., S1, S2, etc.) of the multicast stream 21. Switching between streams involves switching between player objects 32 and because each player object 32 is always paired with a particular stream of the multicast stream 21, switching between streams minimizes, if not avoids the latency associated with switching channels as experienced with prior art systems.

According to some embodiments, apparatus 24 includes a plurality of viewing objects 34, such as the four viewing objects V1-V4 shown in FIG. 2. Multiple viewing objects 34 are capable of simultaneously displaying content from respective player objects 32 with which the viewing objects 34 are coupled. The content displayed by the viewing objects 34 depends on the stream paired with the respective player object 34. For the sake of clarity, FIG. 2 only shows viewing object V1 coupled to player object P1 represented by the solid arrow with the option of switching to player objects P2-P4 represented by the dotted arrows.

According to some embodiments, apparatus 24 comprises one or more input devices to enable users to interact with the apparatus 24. The input device can be in the form of a touch screen 36 which can also display content. Alternatively, another touch screen can be provided for user interaction. The input devices can be in the form of a keyboard 38, a controller 40, a card reader 42, a bank note acceptor (BNA) and/or coin acceptor 44, a barcode or ticket scanner 46, or other virtual or physical input device. Apparatus 24 can comprise one or more output devices 48, such as a printer for printing receipts and the like, and one or more loudspeakers. The loudspeakers can be unidirectional loudspeakers for directing audio for a specific channel to a specific area. The input and output devices can be integrated with or connected to the apparatus 24.

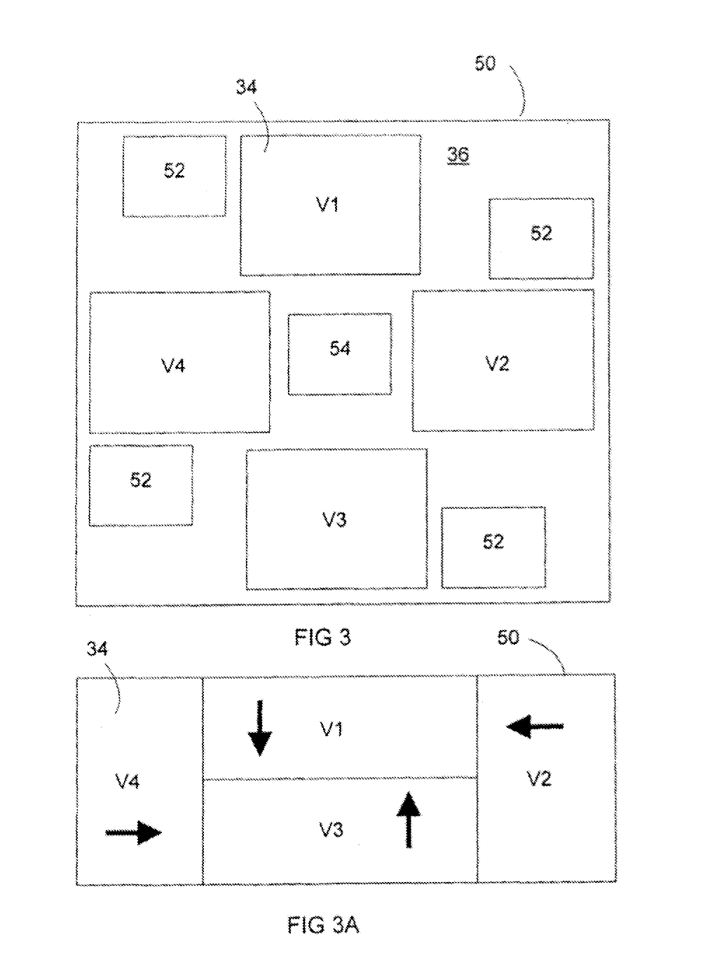

FIG. 3 illustrates an example of another aspect of the present invention, which is in the form of a graphical user interface (GUI) 50 for displaying content supplied from a plurality of sources in a multicast signal. The GUI 50 includes at least one viewing object 34 coupled with one of a plurality of player objects 32, as described above. Each viewing object 34 displays content from the player object 32 with which the viewing object 34 is coupled according to the stream in the multicast stream 21 with which the player object is paired. In the example shown in FIG. 3, the GUI comprises four viewing objects 34, for example to enable four people to watch different content in their respective viewing area.

Whilst FIG. 3 shows viewing objects 34 as substantially square areas, it will be appreciated that they can be any shape. In some embodiments viewing objects 34 can be contiguous such that the viewing objects 34 are tessellated on the touch screen 36, as shown in FIG. 3A, rather than spaced apart as shown in FIG. 3. It will also be appreciated that viewing objects 34 can be oriented in any desired orientation as required. For example, where the apparatus is wall mounted, the viewing objects 34 can be in the same orientation. Where apparatus 24 is in the form of tabletop display 24A, viewing objects 34 can be oriented such that content is displayed in the correct orientation for a user located on each respective side of the tabletop display 24A, as indicated by the arrows in FIG. 3A.

The GUI 50 includes at least one user input field 52 to receive input from a user. Via the input field 52, the user can change the source of the content being displayed in their respective viewing area by their respective viewing object, i.e. effectively switch channels. As described above, switching channels is achieved by coupling the viewing object to a different player object to cause the viewing object to display content from a stream paired with the different player object. In the example shown in FIG. 3, the GUI comprises four input fields 52, one input field associated with each viewing object 34. In this example, the input fields 52 are shown separately from their associated viewing areas. However, in alternative embodiments, the input field can be displayed with the viewing area. In some embodiments, the input field 52 displays virtual arrows to change the channel up or down and/or a virtual number pad to enable the user to key in a channel number.

According to some embodiments, GUI 50 includes at least one field 54 for displaying information relating to content displayed by one or more of the at least one viewing objects 34. For example, performance statistics and/or betting odds relating to a sports event displayed by at least one of the viewing objects 34 can be displayed in field 54. Whilst FIG. 3 shows a single field 54 located centrally in the GUI 50, GUI can comprise multiple fields 54, for example, with one field 54 associated with each viewing object 34.

Alternatively, one or more fields 54 can appear within viewing objects 34. In other embodiments, the related information can be displayed in an overlay above the content to which it relates such that the information can be viewed without obscuring the content beneath.

According to some embodiments, field 54 also enables users to select content, and for example place a wager. For example, a user can view betting odds in field 54 relating to a race being displayed in their respective viewing area. Via input field 54, the user can select one of the contenders, e.g. a horse, enter a stake, e.g. $10 and select a wager format, e.g. win, place, trifecta etc. The user can pay for the wager via card reader 42 or bank note acceptor (BNA) 44 and communications network 28 for connection to the relevant financial institution to authorize payment. A receipt for the wager can be printed by printer 48. Other methods for enabling and/or purchasing content and/or for entering contests and/or wagers, such as entering codes or a PIN which are associated with, or have associated, wagers, contests, etc . . . .

Meanwhile, other users can watch different content in other viewing areas. For example, another user can watch a grand prix or the like and select the desired viewing angle, e.g. in car with the user's favoured driver.

In some embodiments, users can view food and drink menus for the venue in which the present invention is situated, order and pay for their selections via GUI 50 using viewing objects 34, field 54, card reader 42 or bank note acceptor (BNA) 44, communications network 28 and printer 48. Such additional content can be provided by content management module 30 coupled to be in communication with the server 20 or can be provided by an in-house television source.

Where apparatus 24 is in the form of a table top display 24A, apparatus 24A comprises a touch screen 36, a large LCD screen and a layer of toughened safety glass. Table top display 24A can also comprise one or more overlayers as required. Table top display 24A can replace conventional tables and are particularly suited for a group of people such that each user can occupy one side of the table top display and view content of their choice on their own viewing object 34.

For individuals or smaller groups, a bar top or desk top display 24B having the same functionality, but in a smaller device, can be used. Alternatively, individuals can be provided with a display tablet 24C having the same functionality, for example, as a substitute for a menu, which the user can take to their table or with which the user can move around the venue.

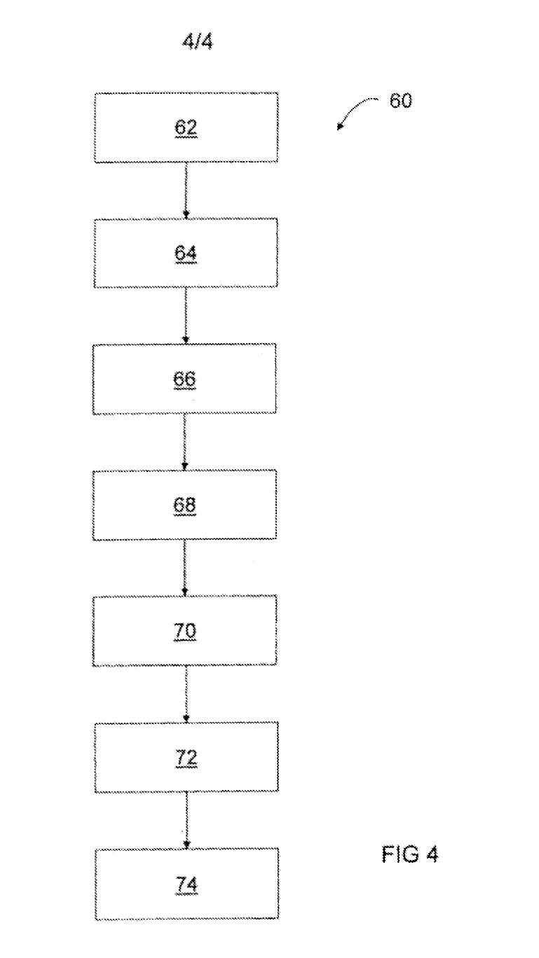

Referring to the general flow diagram of FIG. 4, another aspect of the present invention is a method 60 for managing content supplied from a plurality of sources in respective signals, such as, but not limited to free to air television, video on demand (VOD), satellite television, web browser content, such as content from a specific website, static content, content management systems 30 etc., as described above. In some embodiments, such methods 60 can include at step 62 server 20 receiving modulated RF signal 8 from modulator 16.

The method 60 includes at step 64 server 20 transcoding one or more of the signals and/or resizing content in the signals as required.

At step 66, method 60 includes combining the transcoded and/or resized signals into the multicast stream 21.

At step 68, method 60 includes splitting the multicast stream 21 comprising the plurality of streams representing the signals into the constituent streams. The method 60 includes at step 70 pairing a player object 32 with each constituent stream.

The method 60 includes at step 72 coupling a viewing object 34 with one of the player objects 32 to display content from the stream paired with the respective player object.

The method 60 further includes at step 74 switching a signal displayed by the viewing object 34 by coupling the viewing object with a different player object.

It will be appreciated that server 20, master control server 26 and apparatus 24 can comprise storage media in the form of memories comprising computer readable media. The computer readable media comprise computer readable program code components, at least some of which are selectively executed by respective processors to cause the execution of embodiments of the present invention described herein.

It should be appreciated that use of the term “multicast” in this specification is intended to refer to any stream comprising signals from a plurality of sources.

Hence, the systems, methods, apparatus and user interfaces according to embodiments of the present invention thus address or at least ameliorate the aforementioned problems of the prior art by pairing player objects 32 with respective streams of the multicast stream 21 and coupling a viewing object 34 in an apparatus 24 with one of the player objects to display the content from the respective stream. Therefore, embodiments of the present invention enable users to switch between streams without the latency of switching experienced with prior art systems, methods and apparatus. Multiple viewing objects 34 in a single apparatus 24 enable users to view multiple streams simultaneously.

### Multi-Dimensional Sound System

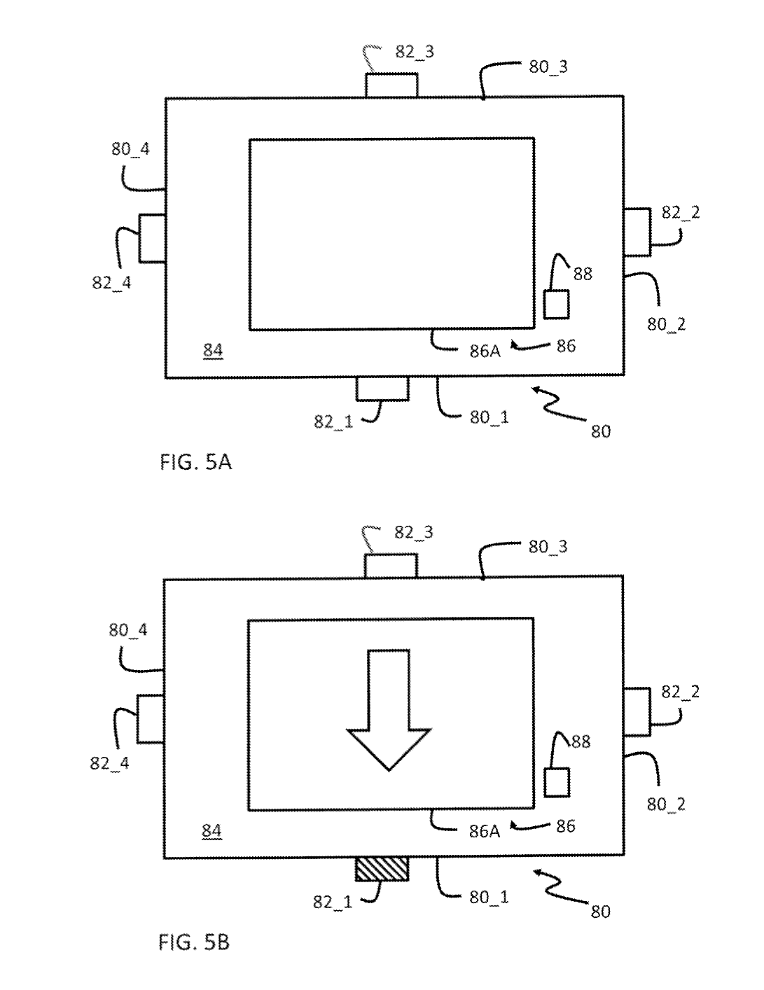

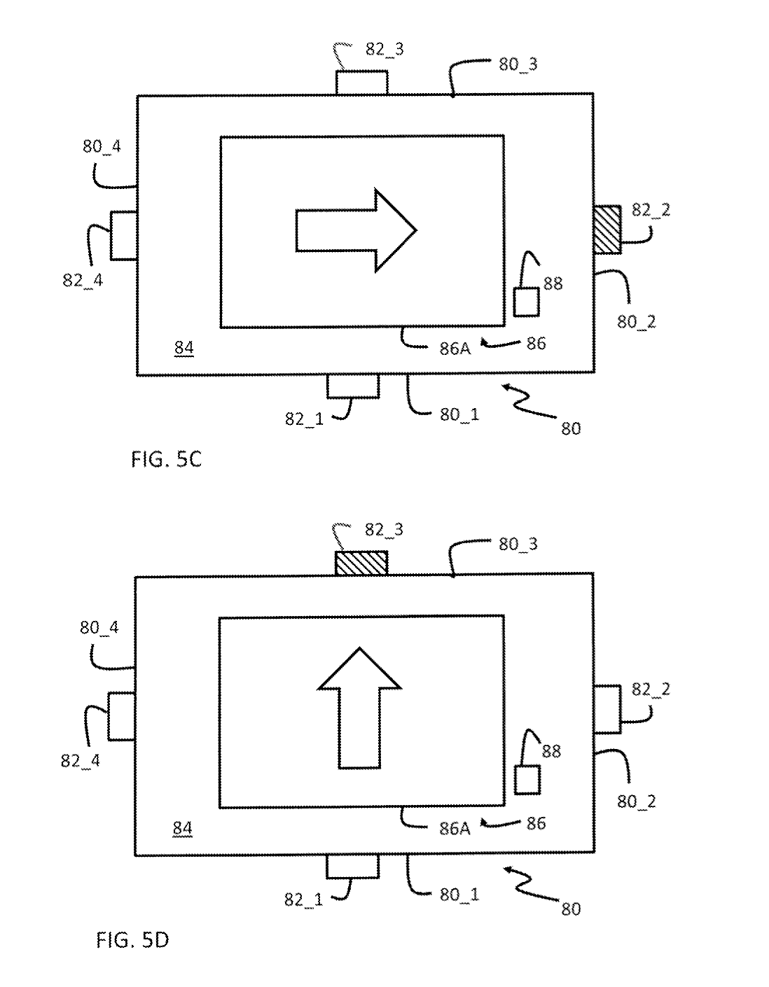

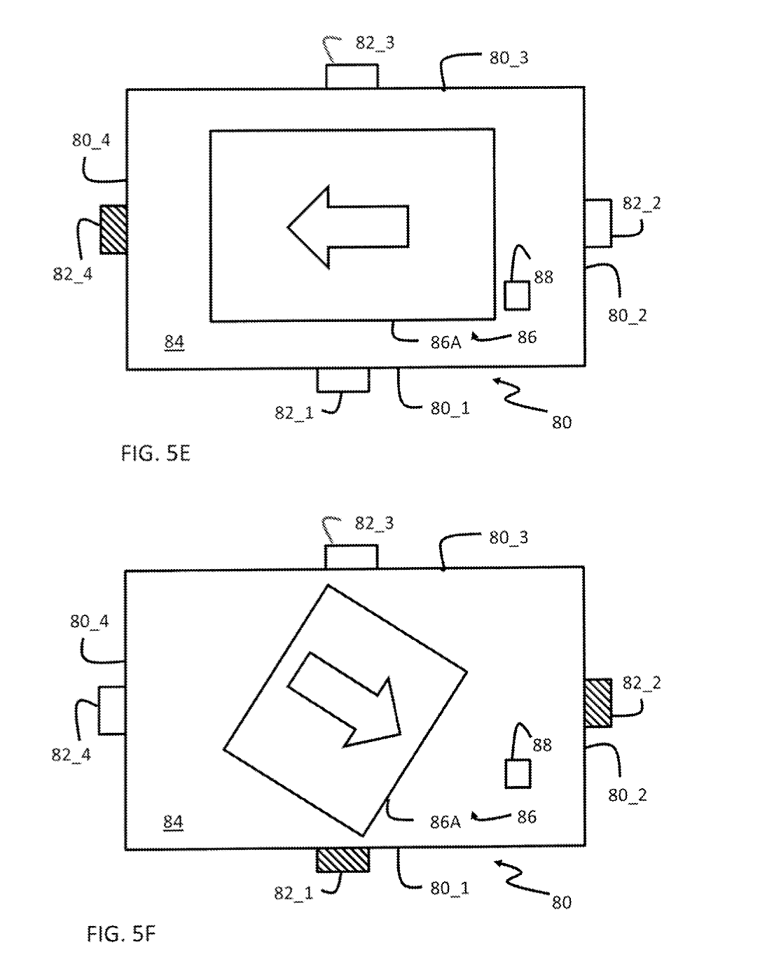

With reference to FIG. 5A, a simplified diagram of an exemplary table 80 is shown. This exemplary embodiment of table 80 has 4 sides, 80_1, 80_2, 80_3, and 80_4. Each side has an associated audio device 82_1, 82_2, 82_3, and 82_4 for the playback of audio associated with content being displayed on the touchscreen display 84. As discussed more fully below, the audio being played through a specific audio device 82_1, 82_2, 82_3, and 82_4 may be associated with specific content associated with a display area that is currently in front of, or in view of user(s) located on the related side or position of the device or table 80. Alternatively, the audio may be associated with content associated with a display area that is currently not in front if, or in view of the user(s) located on the related side or position of the device or table 80 (see below). Furthermore, the audio being played through a specific audio device 82_1, 82_2, 82_3, or 82_4 may be a mix of audio associated with one or more sources. Lastly, in some embodiments, a source of content in some embodiments, may include audio only. The system may display content in one or more display areas 86 on the touchscreen display 84. For the purposes of explanation of a number of features, a single display area 86A is shown in FIG. 5A. Each audio device 82_1, 82_2, 82_3, and 82_4 may include one or more devices including one or more speakers, an audio jack, a Bluetooth transmitter, or any other such device capable of outputting audio. Furthermore, the table 80 is not limited to any one shape, but could be without limitation, an oval, a circle, a square, or other uniform or non-uniform shape.

In general in one aspect of the present invention, the sound or audio associated with the content being displayed with one of the display areas will be played in one or more of the audio devices 82_1, 82_2, 82_3, and 82_4 as a function of the orientation of the content. For example, in FIG. 5B, the orientation of the content in the display area 86A is shown by the arrow contained therein. As shown the content in display area 86A is towards side 80_1. Thus, the audio associated with the content in display area 86A is played through audio device 82_1. In FIG. 5B, this is indicated by the shading of audio device 82_1. However as noted above, in some instances, the audio being played through a specific audio device 82_1, 82_2, 82_3, or 82_4 may be associated with specific content may be associated with content associated with a display area that is currently not in front of, or in view of the user(s) located on the related side or position of the device or table 80 (see below). Again, the audio being played via one of the audio devices 82_1, 82_2, 82_3, and 82_4 may be a mix of audio from two or more content sources.

In one aspect of the present invention, the orientation of the display area 86A may be changed, modified or adjusted. Accordingly, the audio device or audio devices through which the audio associated with the content being displayed in the display area 86A is played may also be changed, modified or adjusted.

For example, in one embodiment, the orientation of the content in the display area 86A may be adjusted in present angular steps, such as 45 or 90 degrees, through the user interface. In the illustrated embodiment, the user interface may include a rotate button 88 which rotates the content by the preset angular step per actuation. In other words, every actuation of the rotate button 88 may rotate the content the angular step, e.g. in the counter-clockwise direction, e.g., 90 degrees. A separate button may be provided to rotate the content in the opposite direction. Alternatively, the touchscreen device may be used to rotate the content. For example, the touchscreen device may be capable of detecting multiple touches and detect a twisting motion of multiple touches which would cause the content to rotate in the same direction.

With respect to FIG. 5C, the content in the display area 86A is facing side 80_2 and therefore the audio associated with the content in the display area 86A is being played on the audio device 82_2.

With respect to FIG. 5D, the content in the display area 86A is facing side 80_3 and therefore the audio associated with the content in the display area 86A is being played on the audio device 82_3.

With respect to FIG. 5E the content in the display area 86A is facing side 80_4 and therefore the audio associated with the content in the display area 86A is being played on the audio device 82_4.

In another aspect of the present invention, the orientation of the content in the display area 86A is not limited to facing one side directly, but may be orientated at any angle. For example, as shown in FIG. 5F, the content in the display area is facing between side 80_1 and side 80_2. In this embodiment, the audio associated with the content of the display area 86A is played on both the audio device 82_1 and the audio device 82_2.

In one embodiment, the relative volume levels are derived using a set of formulas based on the angular rotation of the content relative to the origin. A set of formulas which may be used in the context of a four-sided embodiment of the invention is shown in Tables 1-3, below.

TABLE 1
Sample Terms (4-sided embodiment)

| Term | Description |
|---|---|
| CCDR | Value for Counter-Clockwise Degrees Rotation in |
| | relation to the sound from the Screen of Origin |
| SOV | Screen of Origin Volume Level (%) |
| TSV | “Twist and Shout” Volume as applicable for each side |
| rTi | TSV increasing voluming Rotation Range Top Limit |
| rBi | TSV increasing voluming Rotation Range Bottom Limit |
| rTd | TSV decreasing voluming Rotation Range Top Limit |
| rBd | TSV decreasing voluming Rotation Range Bottom Limit |
| _R | Applies to the Screen which is to the Right of the Screen |
| | of Origin (_R of Screen 2 is Screen 3, _R of Screen 4 is |
| | Screen 1, etc.) |
| _T | Applies to the Screen which is to the “Opposite” of the |
| | Screen of Origin (_T of Screen 1 is Screen 3, _T of |
| | Screen 2 is Screen 4, etc.) |
| _L | Applies to the Screen which is to the Left of the Screen |
| | of Origin (_L of Screen 2 is Screen 1, _L of Screen 4 is |
| | Screen 3, etc.) |

TABLE 2
Sample Formulas (4-sided embodiment)
Sample Formulas

_T Limits = _R Limits + 90
_L Limits = _T Limits + 90 (rTi_L = rTi_T + 90)

| | |
|---|---|
| If CCDR <= rBi_R or CCDR >= | TSV(_R) = 0 |
| rTd_R | |
| If rBi_R < CCDR <= rTi_R | TSV(_R) = SOV/(rT − rB) * (CCDR − (rTi − rBi)/2) |
| If rTi_R < CCDR <= r_Bd_R | TSV(_R) = SOV |
| If rBd_R < CCDR < rTd_R | TSV(_R) = SOV/(rT − rB) * (rTd − CCDR) |
| If CCDR <= rBi_T or CCDR >= | TSV(_T) = 0 |
| rTd_T | |
| If rBi_T < CCDR <= rTi_T | TSV(_T) = SOV/(rT − rB) * (CCDR − (rTi − rBi/2) − |
| | (rTI_T + rBi_R)*(2*SOV/100) |
| If rTi_T < CCDR <= r_Bd_T | TSV(_T) = SOV |
| If rBd_T < CCDR < rTd_T | TSV(_T) = SOV/(rT − rB) * (rTd − CCDR) |
| If CCDR <= rBi_L or CCDR >= | TSV(_L) = 0 |
| rTd_L | |
| If rBi_L < CCDR <= rTi_L | TSV(_L) = SOV/(rT − rB) * (CCDR − (rTi − rBi)/2) − |
| | (rBd_L + rTi_T)*(4/3 * SOV/100) |
| If rTi_L < CCDR <= rBd_L | TSV(_L) = SOV |
| If rBd_L < CCDR < rTd_L | TSV(_L) = SOV/(rT − rB) * (rTd − CCDR) |

TABLE 3
Sample Calculations (4-sided embodiment)

| Value | _R Formula | _T Formula | _L Formula |
|---|---|---|---|
| CCDR | 196 | 196 | 196 |
| SOV | 70 | 70 | 70 |
| rBi | 15 | 105 | 195 |
| rTi | 45 | 135 | 225 |
| rBd | 135 | 225 | 315 |
| rTd | 165 | 255 | 345 |
| TSV | 0.00% | 70.00% | 2.33% |

With respect to FIGS. 5A-5F, a single display area 86A is shown. It should be noted that the system is not limited to a single display area 86. In another words, multiple display areas 86 may be shown at the same time, each with respective, associated content. Each content or display area may be rotated, as discussed above. Furthermore, the associated audio with the content may be switched to, or shared with, more than one audio device as discussed above. If the audio associated with the content of more than one display areas 86 is being played through a single audio device 82, then the audio signals may be mixed appropriately, e.g., equally, or using a ratio based on one or more parameters.

In one embodiment, the system may include one or more predefined configurations. Each configuration includes a predetermined number of display areas, as well as a location on the touchscreen display 84. Alternatively, or after initial placement, display areas may be added, deleted, resized, rotated or otherwise manually configured.

In one aspect of the present invention, the system includes a user interface that may be implemented, for example, by the touchscreen display 84. In one aspect, a content button (not shown) associated with each displayer area 88A may be provided. Actuation of the content button allows a user to cycle through the available content for the associated display area 88A. The user interface may be configured in any suitable manner to allow the user to change the content for a display area 88.

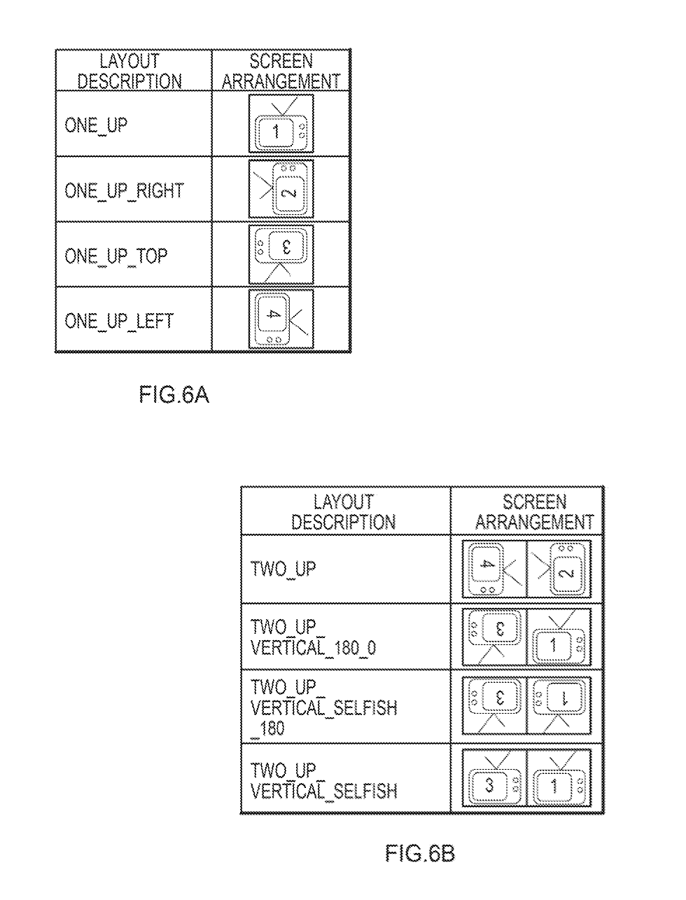

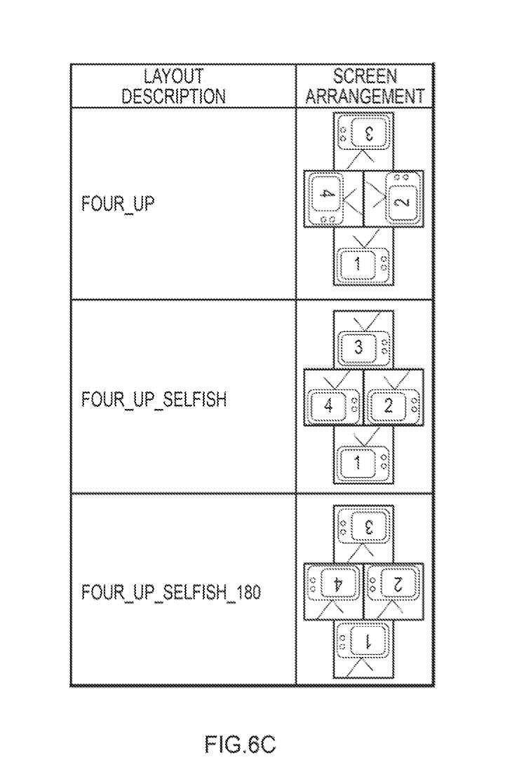

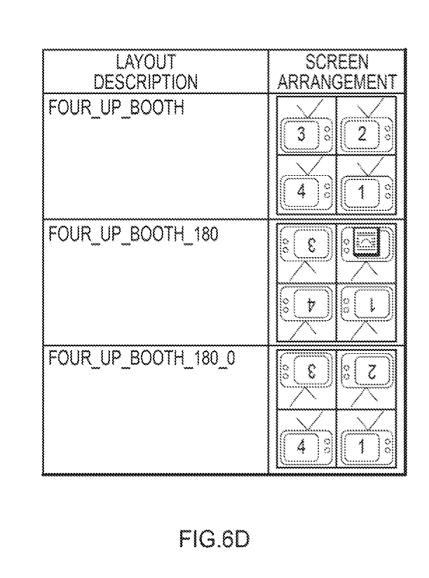

With respect to FIGS. 6A-6D, in one embodiment, the display screen may include up to four display areas and the system may include 14 predetermined configurations. Other embodiments may include any number of display areas or predetermined configurations. The preset configurations in the embodiment of FIGS. 6A-6D are categorized as being: ONE_UP, TWO_UP, or FOUR_UP. The category names are indicative of the number of display areas being displayed, as well as the orientation of the respective display areas.

With reference to FIG. 6A, in the instant embodiment, there are four ONE_UP configurations: ONE_UP, ONE_UP_RIGHT, ONE_UP_TOP, and ONE_UP_LEFT. In each configuration, the single display area 86 has the orientation as shown in the icon to the right. It should be noted that the icon may be displayed as buttons on the touchscreen display. Actuation of a button, implements the respective configuration.

With reference to FIG. 6B, in the instant embodiment, there are four TWO_UP configurations: TWO_UP, TWO_UP_VERTICAL_180_0, TWO_UP_SELFISH_I 80, and TWO_UP_SELFISH. In each configuration, the two display areas 86 have the orientation as shown in the icon to the right. It should be noted that the icon may be displayed as buttons on the touchscreen display. Actuation of a button, implements the respective configuration.

The configuration designation “SELFISH” is only used in multiple display area configurations and is used when all of the current display areas are orientated in the same direction. More about the SELFISH configurations may be found below.

With reference to FIGS. 6C-6D, in the instant embodiment, there are six FOUR_UP configurations: FOUR_UP, FOUR_UP_SELFISH, FOUR_UP_SELFISH_180, FOUR_UP_BOOTH, FOUR_UP_BOOTH_180, and FOUR_U_180_0. In each configuration, the four display areas 86 have the orientation as shown in the icon to the right. It should be noted that the icon may be displayed as buttons on the touchscreen display. Actuation of a button, implements the respective configuration.

In one embodiment, the system or platform allows a user, which can include patrons, customers, consumers, or employees of the property or business at which the system is installed, to change or modify content sources or the number of, and configuration or, the display areas. The system may include an intuitive button-icon interface that provides the ability to switch quickly between content (such as between one or more streaming video content and/interactive content) while allowing instantaneous updates to the number of sub-screens (display areas) shown on the touchscreen device 84. Although, the disclosed embodiment allows the touchscreen display to simultaneously display 1, 2, or 4 display areas, it should be noted that the present invention is not limited to any specific number of display areas that may be displayed at any one time.

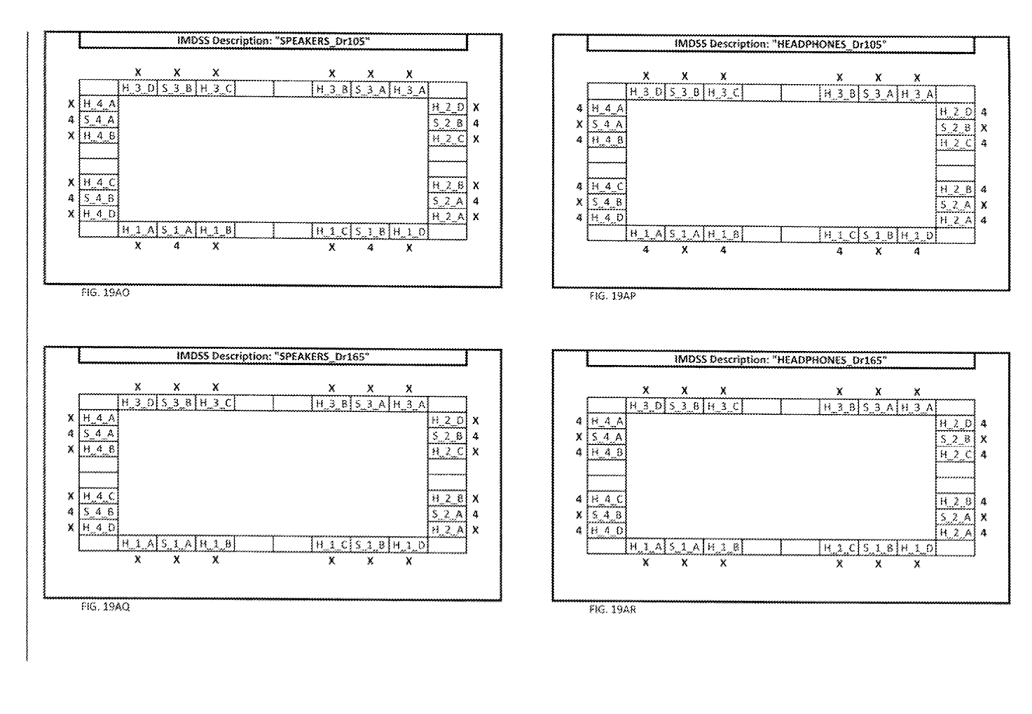

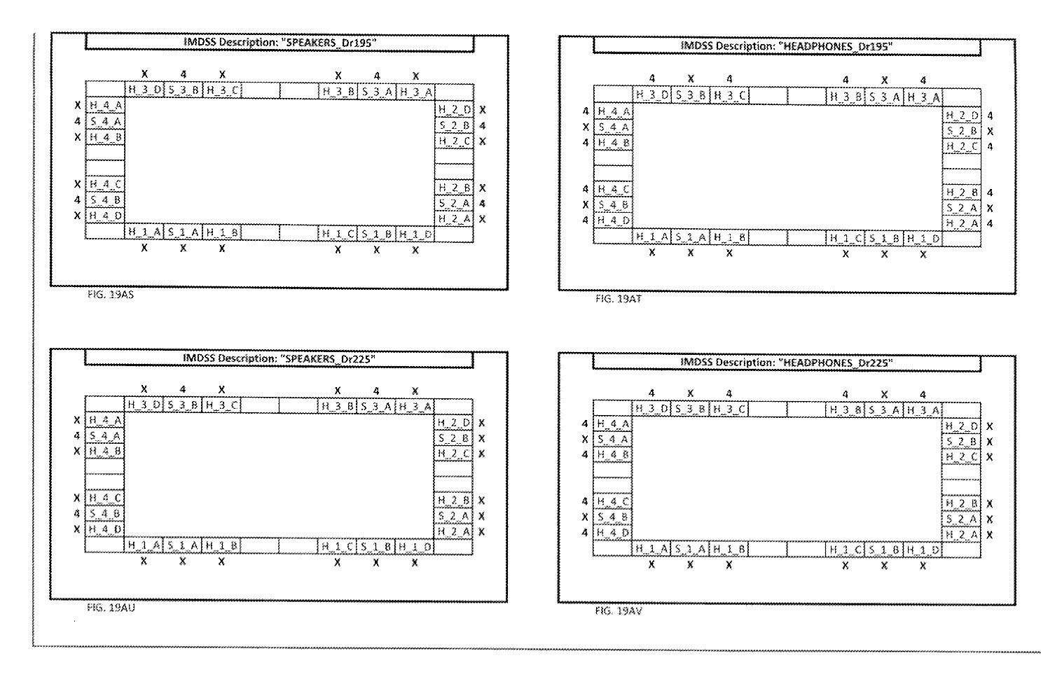

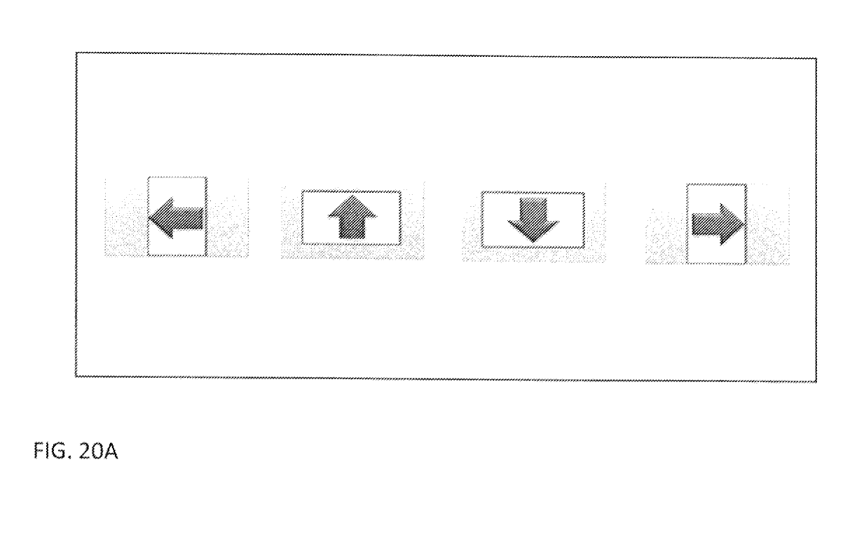

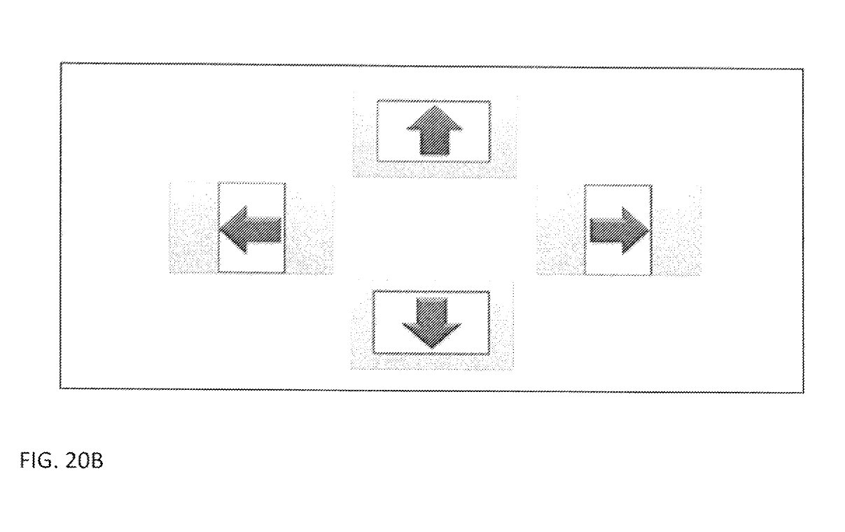

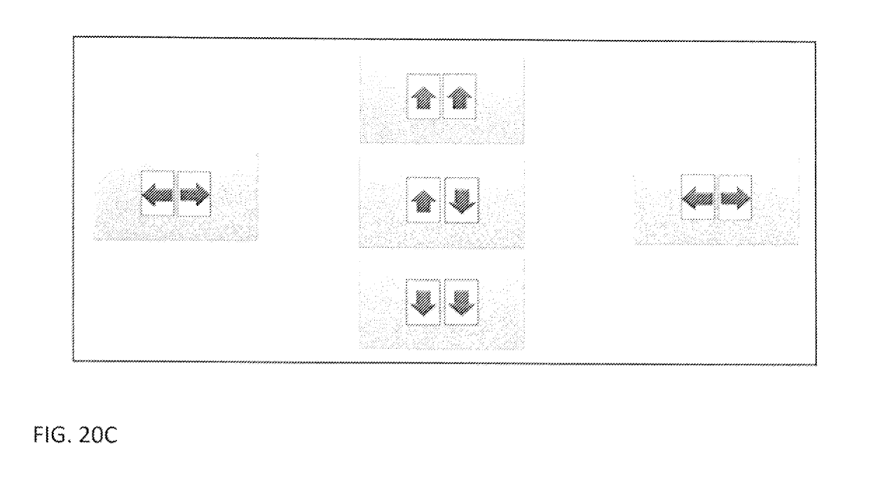

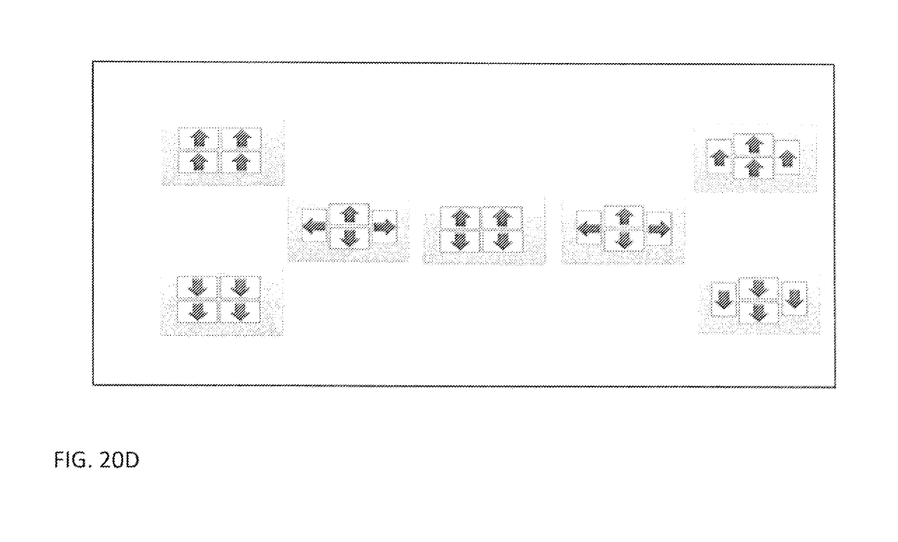

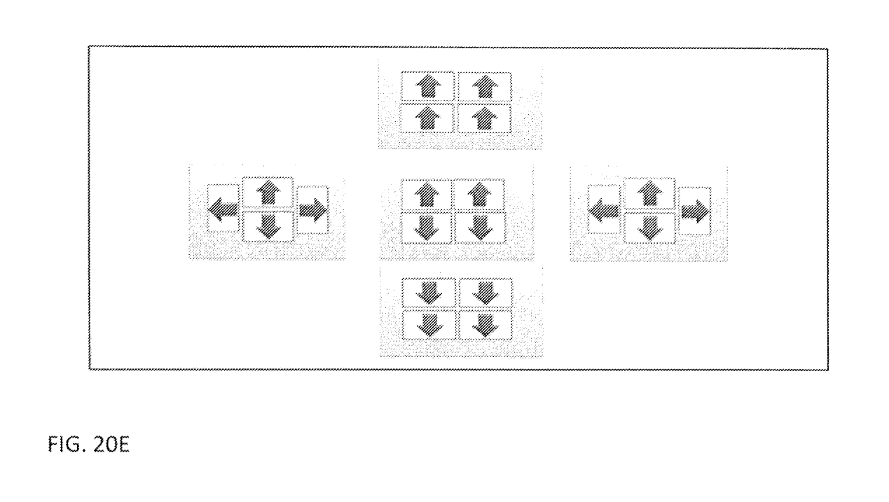

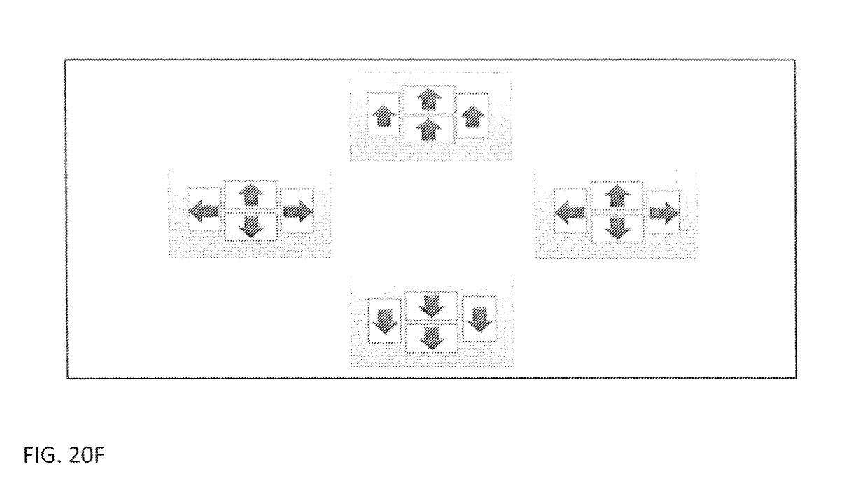

With reference to FIGS. 20A-20F, in another aspect of the present invention, the user interface allows the user(s) to select a desired configuration from a set of predetermined or predefined configurations. In one embodiment, the user interface includes a “layout change” button. (not shown) Actuation of the layout change button allows the user to select the desired layout or configuration. For instance, actuation of the layout change button may cause a menu to be displayed that allows the user to select the number of display areas and/or general configuration:
One-Up (one display area)
Two-Up (two display areas)
Three-Up (three display areas)
Four-up (four display areas)
N-up (N display areas)

It should be noted that in a particular embodiment, more or fewer configurations may be available. Selection of a menu item, causes a graphic containing the configurations available under each general configuration. The user can select a graphic associated with a deserved configuration. With reference to FIG. 20A, the four available configurations with one display area are shown. An alternative view is shown in FIG. 20B. With reference to FIG. 20C, the five configurations available with two display areas are shown. With reference to FIG. 20D, the seven configurations available with 4 display areas, according to a first embodiment, are shown. With reference to FIG. 20E, the five configurations available with 4 display areas, according to a second embodiment, are shown. With reference to FIG. 20F, the 4 configurations available with 4 display areas, according to a third embodiment, are shown.

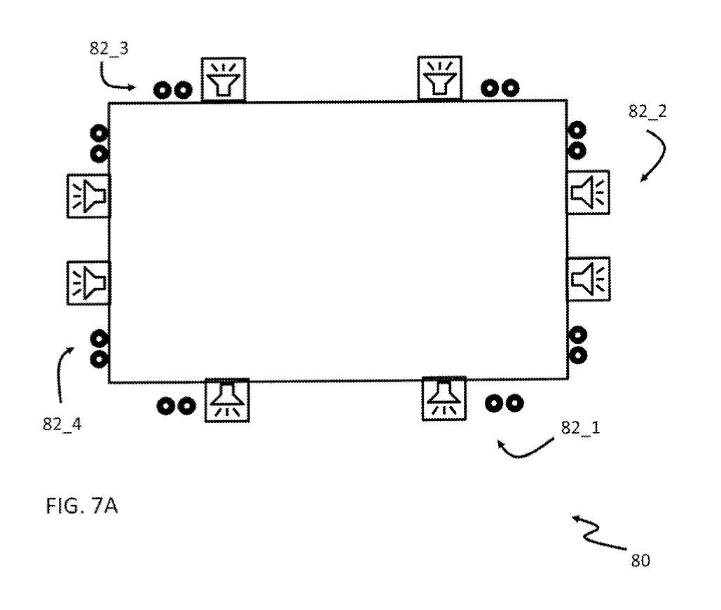

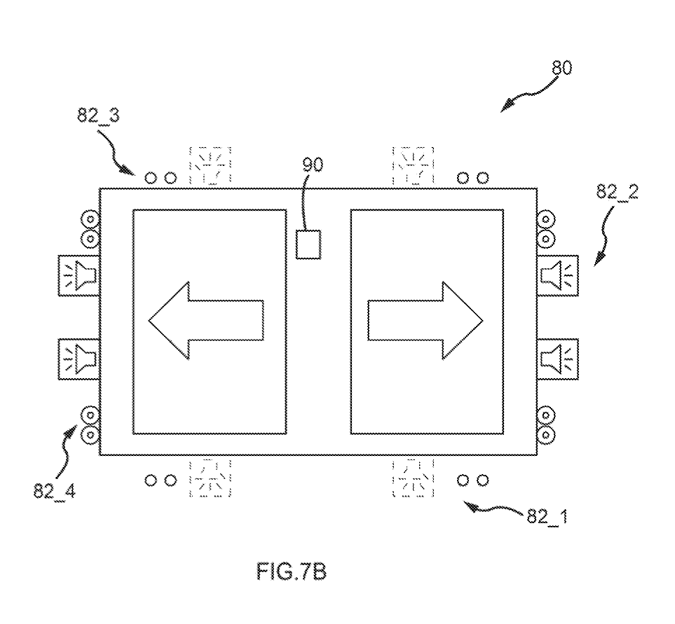

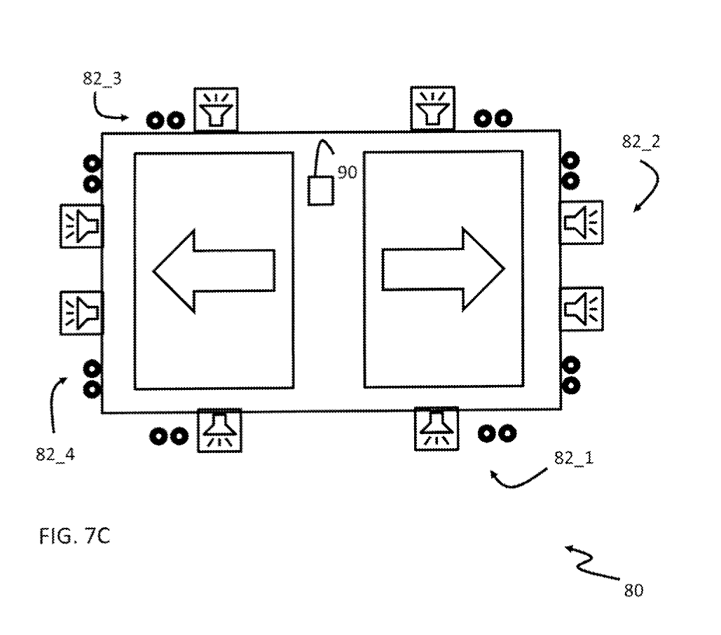

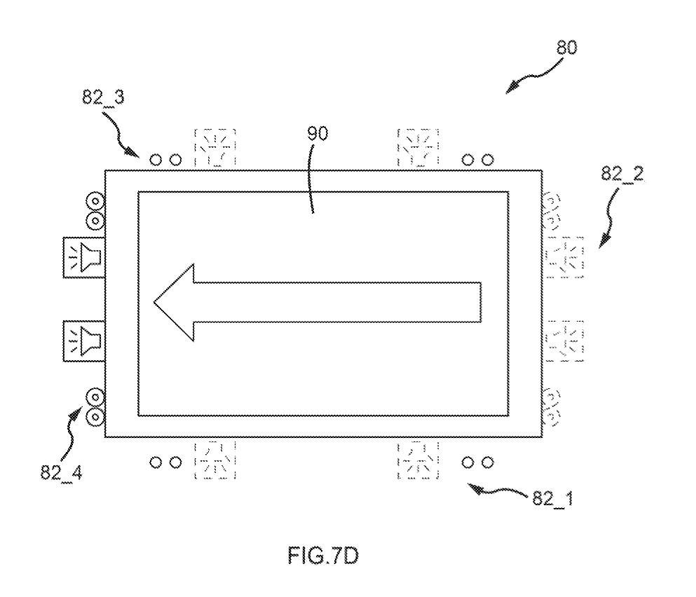

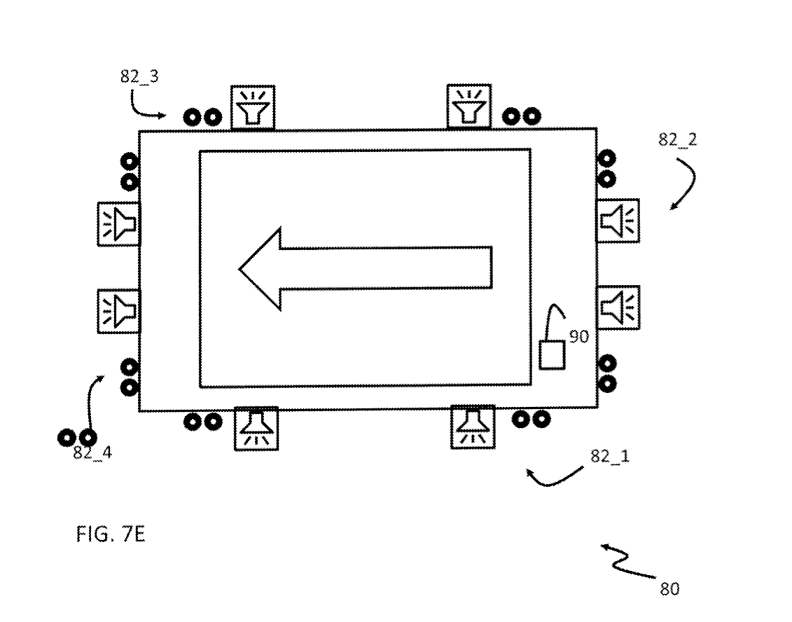

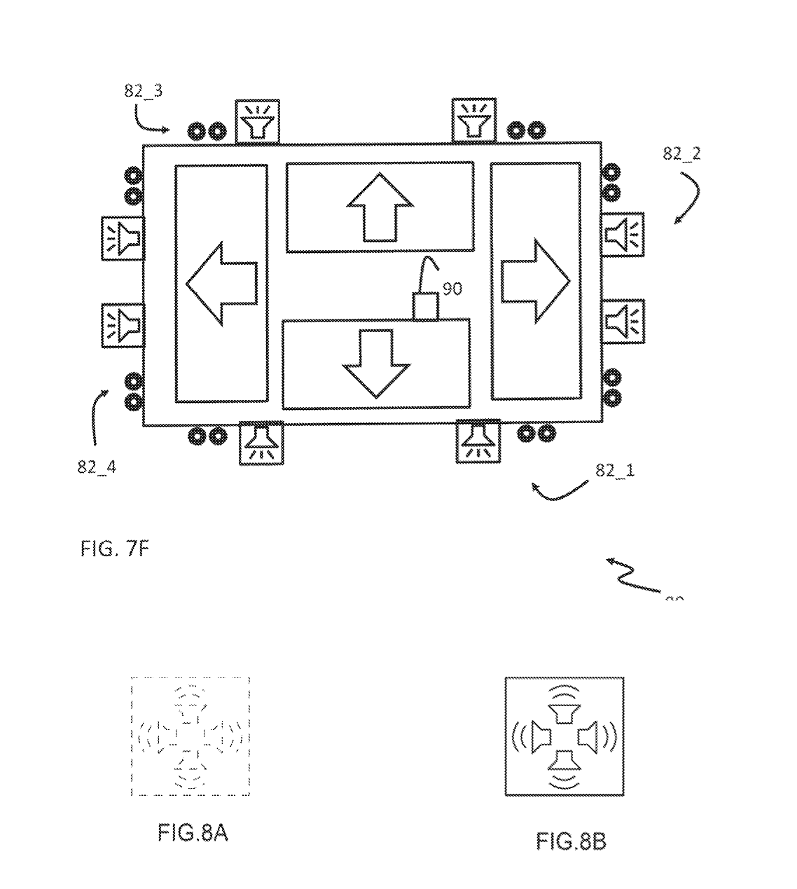

With reference to FIG. 7A, in one embodiment each audio device 82 includes a pair of speakers and 4 audio jacks. It should be noted that, in one embodiment, if a device, such as a pair of headphones are plugged into one of the audio jacks, then one or more speakers may be shut-off. In general, this is feature is configurable. For instance, (1) the speakers associated with the associated audio device may be shut off, or (2) only the speakers associated or located adjacent the audio jack may be shut off, or (3) all speakers may be shut off, or (4) none of the speakers may be shut off. Additionally, embodiments may include zero or more speakers or audio jacks, or may include any number of other audio output devices.

With reference to an example embodiment represented in FIG. 7B, there are currently two display screens being displayed. The orientation of the respective content being indicated by the arrows. As discussed above, in general, as a default, which audio device is used to play the audio associated with the content of a specific display area is a function of the orientation of the associated content. In the illustrated the components of the audio device 82_2 is used to play the audio of the content of the display area on the right since its content is orientated in that direction Likewise, the components of the audio device 82_4 is used to play the audio of the content of the of the display area on the left since its content is orientated to the left as shown. The components of the other two audio devices are inactive. This is indicated in the Fig. by the components being grayed out.

One or more social buttons 90 (only one of which is shown), may be used to share the audio associated with the content of one of the display areas with the other users (through the other speakers). Although only one social button is shown, a social button 90 may be provided for each current display area.

With reference to an embodiment shown in FIG. 7C, if the social button 90 has been actuated then speakers are active and the sound associated with one of the display areas is played through all speakers, i.e., the sound associated with the display areas that is associated with the actuated social button 90. It should be noted that if an audio device is already active (because another display area is facing that side), then the audio signals may be mixed appropriately so that all relevant audio may be heard. Alternatively, in another embodiment, actuation of the social button 90 may (a) make all speakers active and (b) play the sound associated with ALL of the active display areas through all of the active speakers.

With reference to an embodiment shown in FIG. 7D, only one display area is shown and the only active audio devices are located on the left side, the direction based on the orientation of the content. When the social button 90 is actuated, all devices become active (see FIG. 7E).

In FIG. 7F, there are 4 active display areas, each facing a different direction. In this mode, the audio being played through the speakers is based on the direction of the orientation of the content of each display areas.

### INDUSTRIAL APPLICABILITY

This section details a specific embodiment of the multi-dimensional sound system and an interactive table with a multi-dimensional sound system, i.e., the Interactive Multi-Dimensional Sound System™ (IMDSS), as implemented on the InteractivePro™ Table (IPT)

The InteractiveProVisio™ (IPV) Platform and Application for the IPT has the capability to display multiple separate screens to users, providing viewing of television and videos and interaction with multimedia, interactive, and internet content.

The IMDSS utilizes a multi-channel amplifier, eight (8) speakers (2 per IPT side), and sixteen (16) headphone sockets (4 per IPT side).

Sound Directionality

In one mode, the IMDSS implements a method of splitting and directing sound so that audio heard by users is relevant to the screen that they are looking at, in the direction they are looking.

SELFISH and SOCIAL Sound Modes Feature/Functions:

“Selfish Sound Mode”: “Selfish Sound Mode” in one embodiment allows all sound from all viewable User-Screen-Position(s), to be distributed to the sound output devices of ONE (1) ONLY side or facing of the IPT.

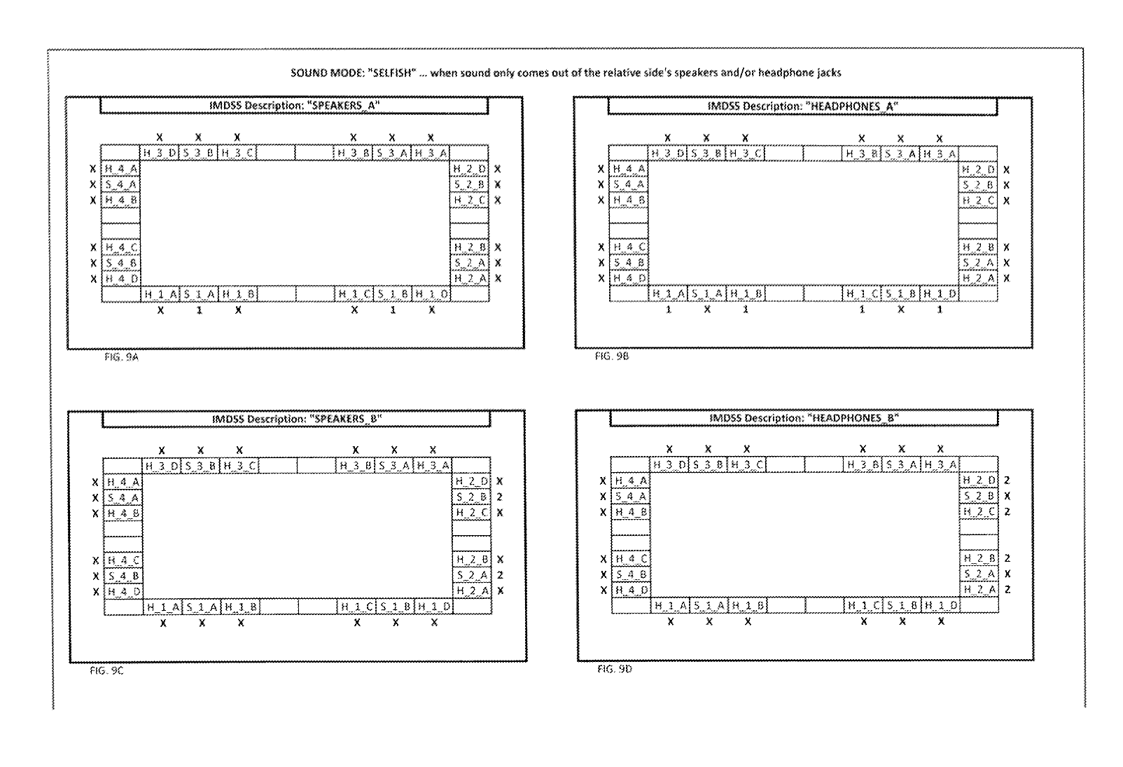

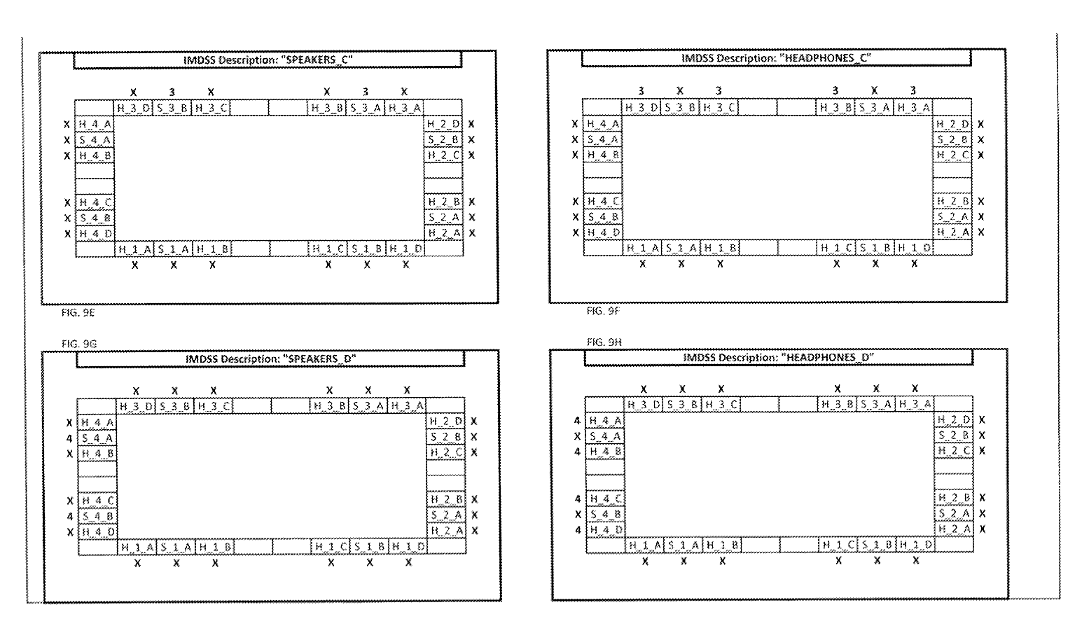

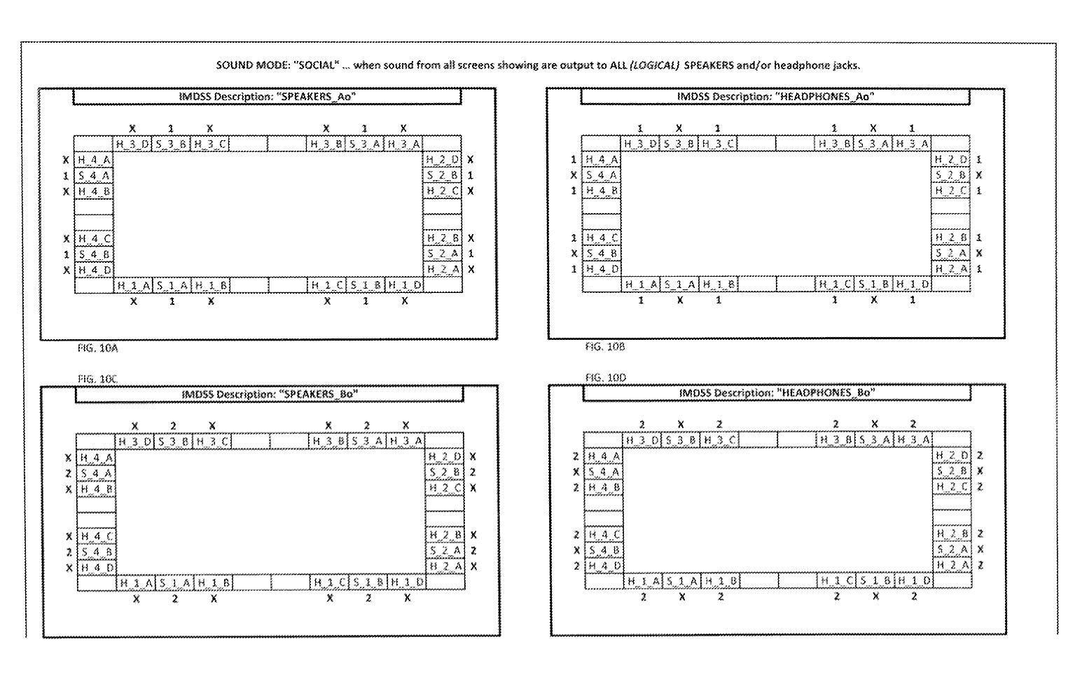

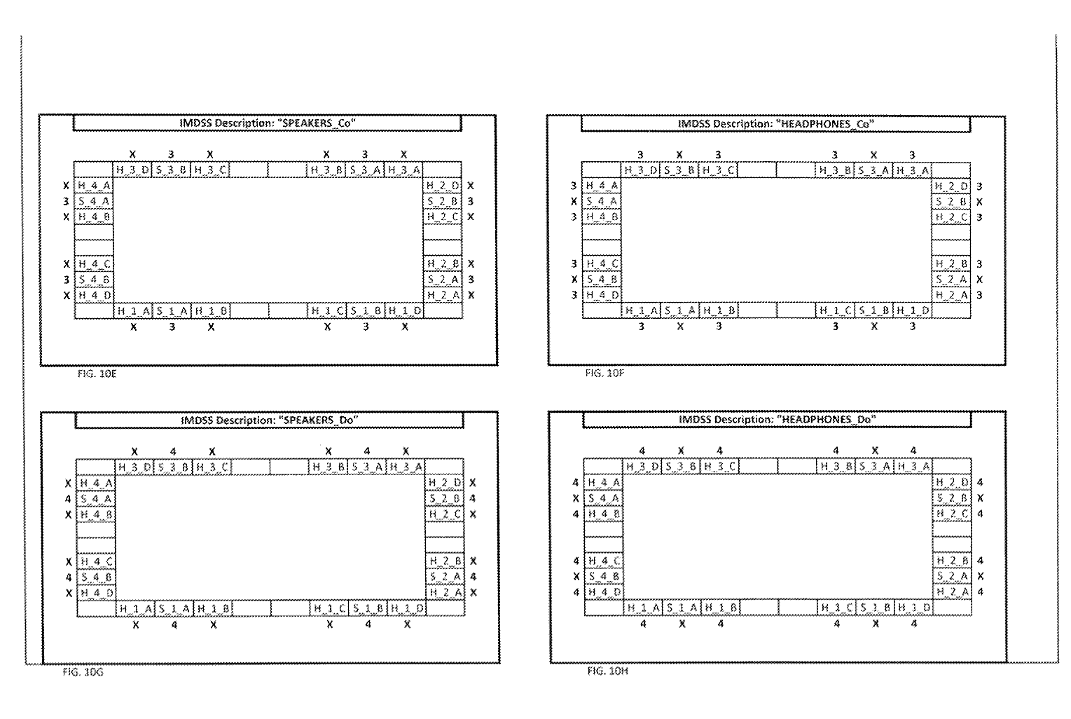

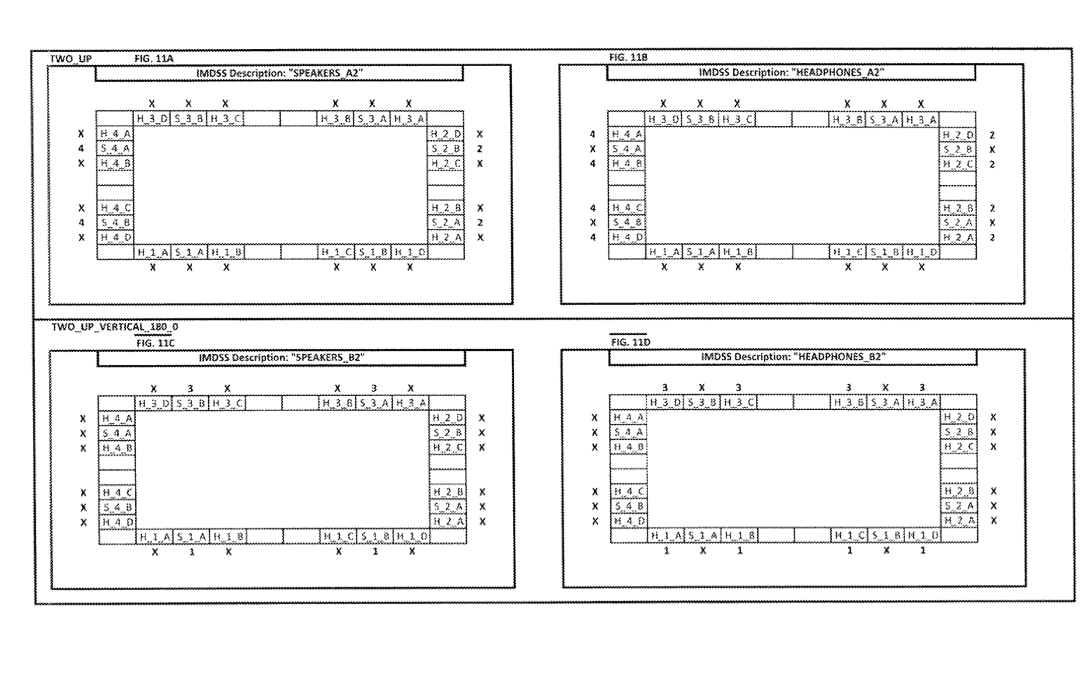

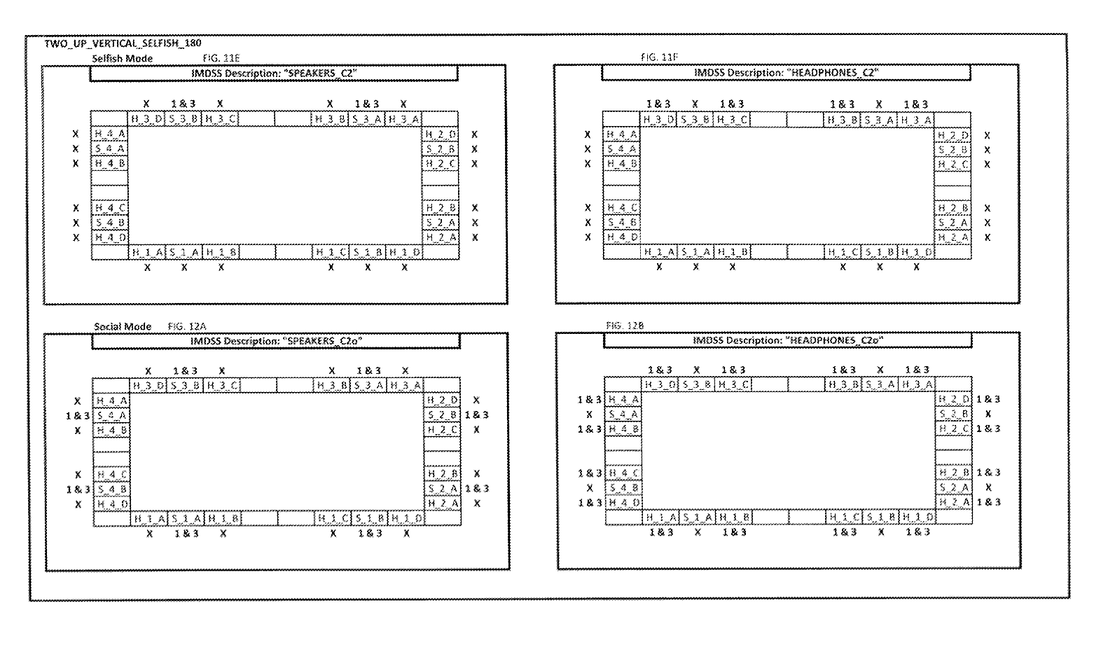

“Social Sound Mode”: When sound from all viewable User-Screen-Position(s) is distributed to the sound output devices of ALL sides of the IPT, the sound output is in “Social Sound Mode.” “Social Sound Mode” may be activated by user or system. If by user, it may be activated by touching the Social Sound Button. A social mode button in inactive mode and active modes are shown in FIGS. 8A and 8B respectively.

“Social Sound Mode Requirements Detail”:

Social Sound Mode Activation and Deactivation: An IPT may provide a Social Sound Button that enables and disables sound from all presently viewable screens to output from the sound output components on ALL four sides of the IPT at the same time.

Configurable “Social” or “Selfish” or “Users” side sound: An IPT may provide the ability to configure whether the Users can decide if Social or Selfish side(s) of the IPT emit sound. In certain embodiments, the IPT may be configured to ensure users do not switch modes.

Twist-n-SH-OUTput™ and/or MDS-Twistah™ Feature Functions

Twist-n-SH-OUTput™ is a user controlled sound direction modification feature that enables moving and rotating sound from the sound output components on one side or facing of the IPT to the sound output components located on another side or facing of the IPT using User touch twist-actions and User button activation.

Product Business Rule (Configuration) OPTIONS:

The Screen of Origin Speaker/Headphone Volume (SOV) may optionally have its sound level reduced through the Twist-n-SH-OUTput functionality.

Twist-n-SH-OUTput may optionally overtake another IPT side or facing's sound output components if there is already sound (regardless of whether it is turned up or not) committed to that ‘another’ IPT side's sound output components.

Twist-n-SH-OUTput may be configurable to allow more than one screen to Twist-n-SH-OUTput to the same ‘other’ IPT side. It may also be configurable to prioritize which sound remains OR overtakes IF more than one screen attempts to Twist-n-SH-OUTput to a same ‘other’ IPT side. Audio signals may be mixed, given priority and/or blocked in various embodiments.

In other aspects of the present invention, the following features may be (individually or jointly) provided:

Resident Content: The content that is actually viewable in a User Screen position or display area. In other words, referencing the IPT Industrial Application, if the TV channel is showing, then that is “resident.” If a web page is showing over a TV channel, that web page is “resident.”

Rotate Function: One or more buttons, at each active/live screen position, may execute a rotating of the “resident” screens once clockwise (or counter-clockwise) per touch.

Switching Function: A user may drag a “resident” screen towards another user's screen and then the two screen switch positions (auto-filling the active space). If the screens are associated with user accounts, such a swap may include an active/open web-account to move with the screen so the user(s) shares/swaps account(s). This may be configurable, to share, swap, or do neither to accounts.

Position Lock Function: A button, may be placed at one or more active/live screen positions, and may be configured to lock the screen so neither the Rotate Function nor Switching Function work. Additionally, a button may be placed and configured to lock configuration of the screen layouts.

Fade: The “FADE” function may allow the content from two different sources to be displayed simultaneously. Content from one source may be interactive, while the other content may be non-interactive, for example, TV/video content. Interactive content may be displayed overlaying the non-interactive content and in a faded format such that the TV/video content is viewable/discernible under the interactive-content. The interactive content remains interactive, i.e., the user may interact with the content.

Split-Screen: The “SPLIT SCREEN” feature may allow each display area to be “split” into two (or more) sub-display areas. Different content may be shown in each sub-display area. The content of the sub-display areas may be interactive or non-interactive.

Additional Audio and Rotation Options:

The Rotate Button may flip the screen at 90-degree increments.

An auto-snap function may exist such that it fixes ‘full’ in a 90-degree position on the screen.

The sound from a rotated screen (fully positioned at whatever 90-degree position) may transfer to the audio jacks associated to that screen's new positioning after a rotation or auto-snap.

USB Ports:

Some embodiments may provide one or more USB ports that may provide a standard charging station and/or also operate as an audio jack.

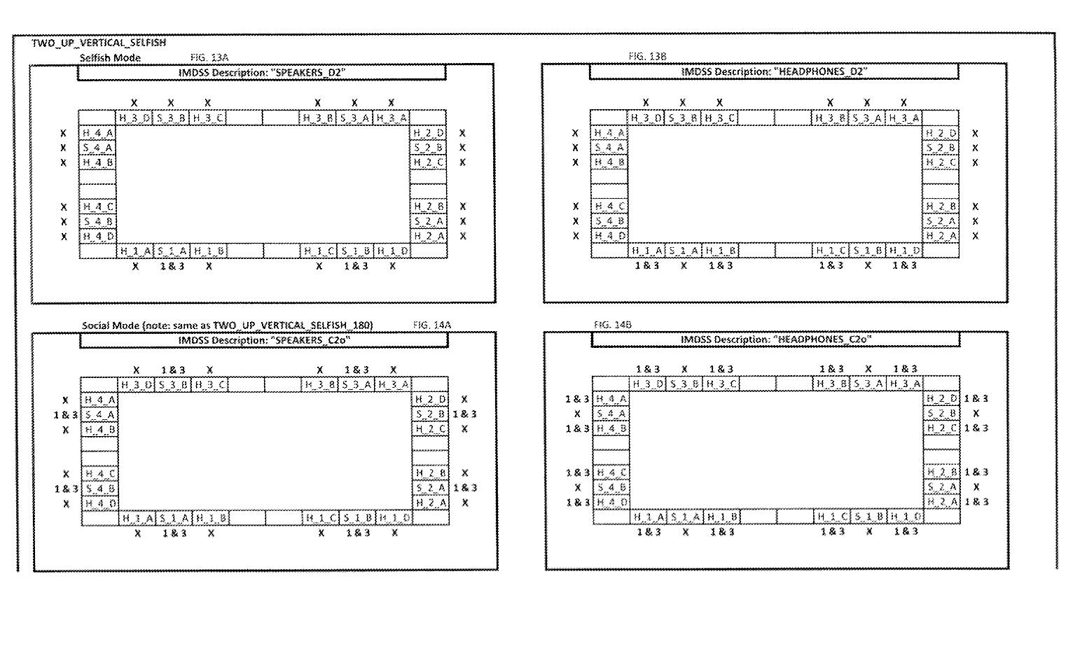

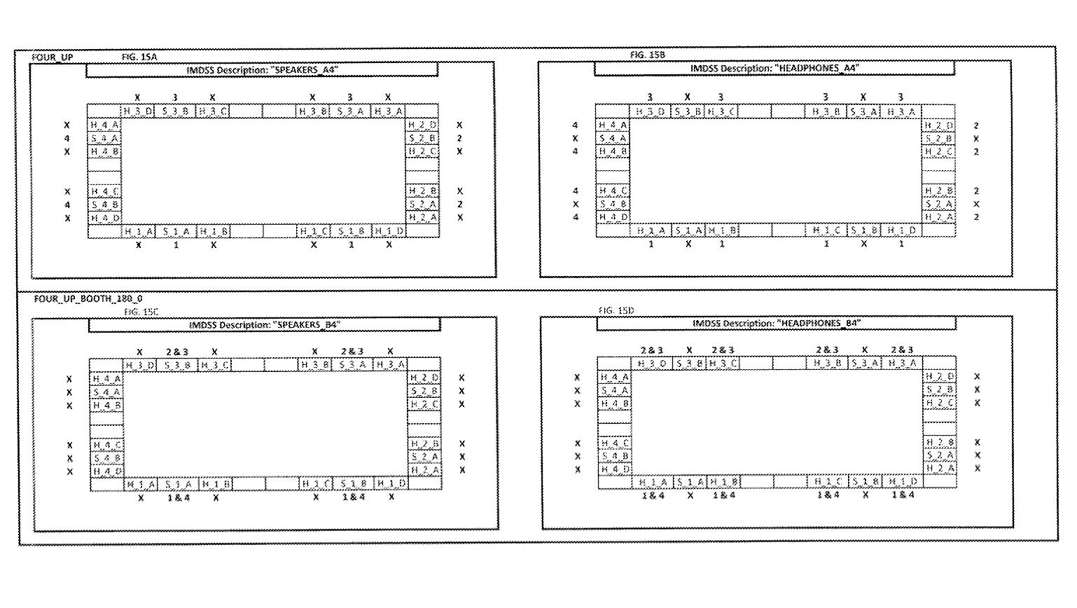

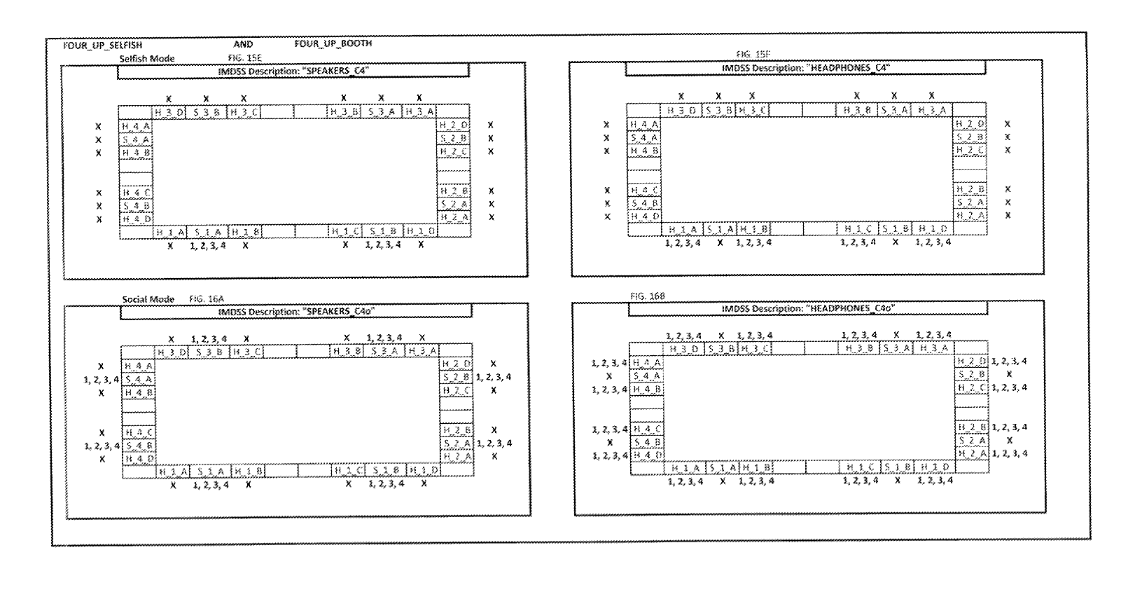

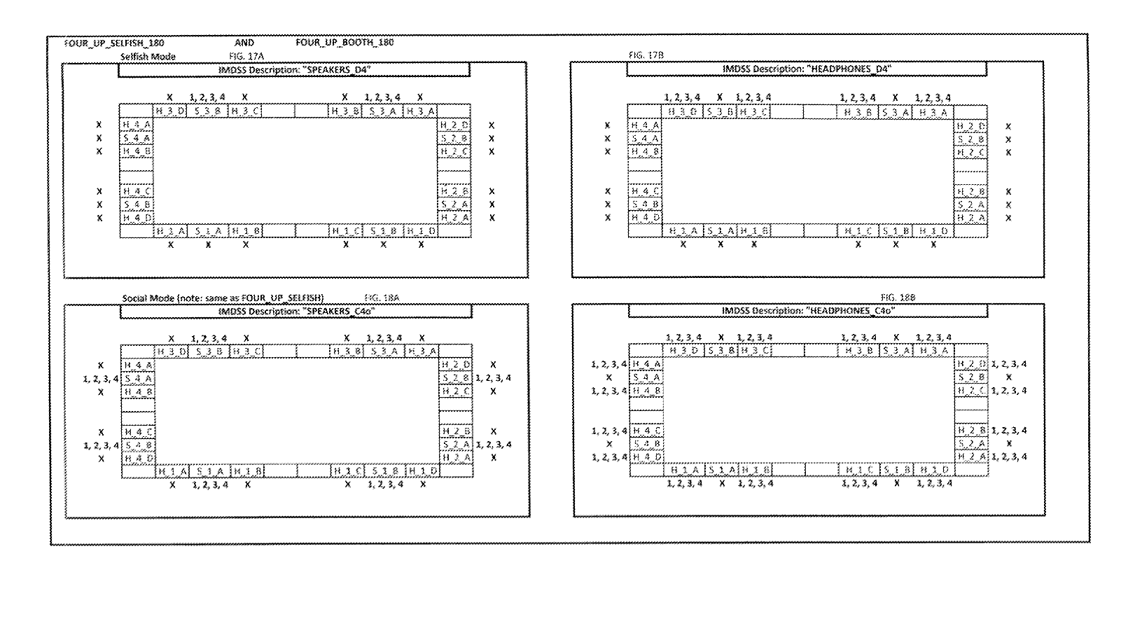

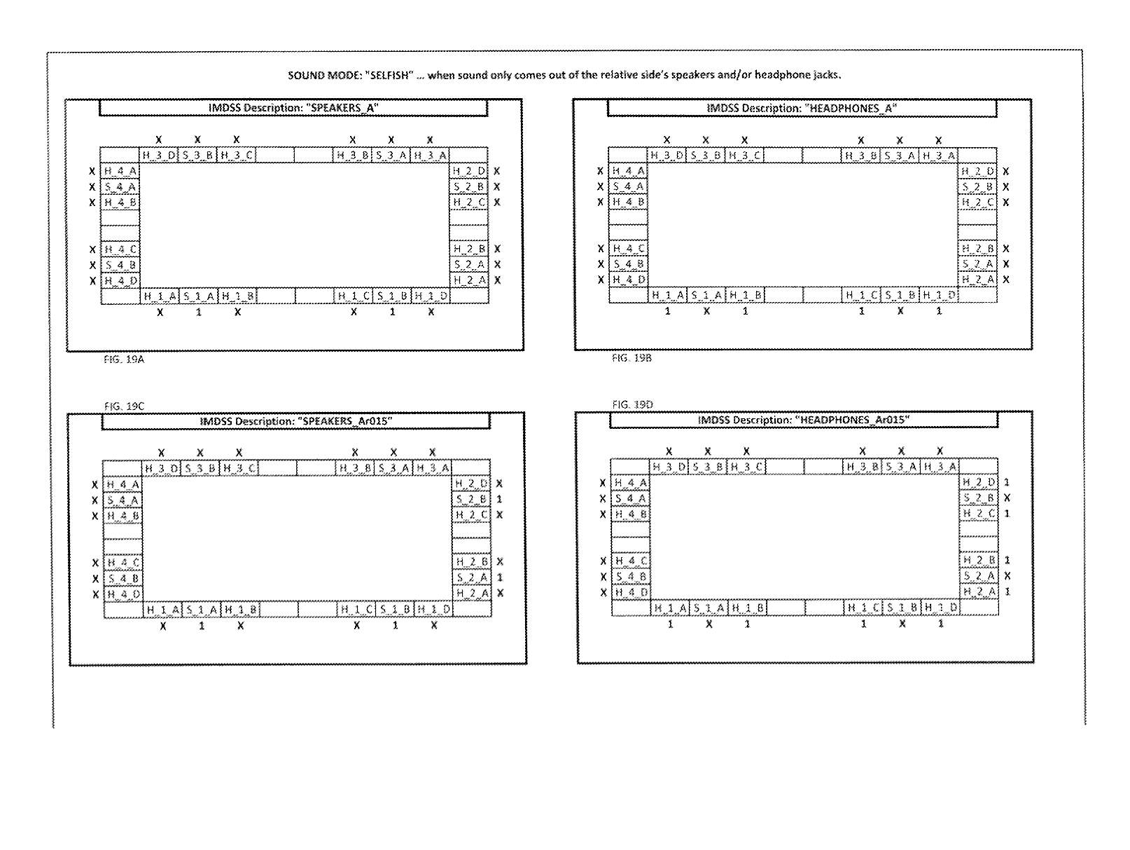

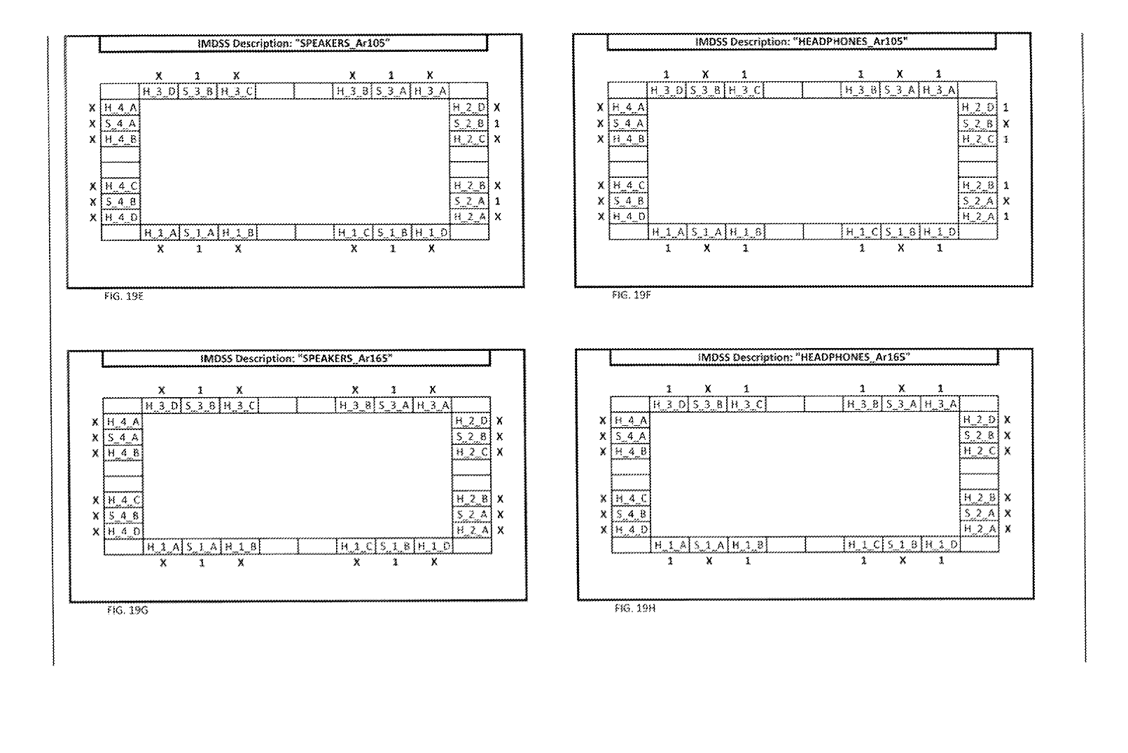

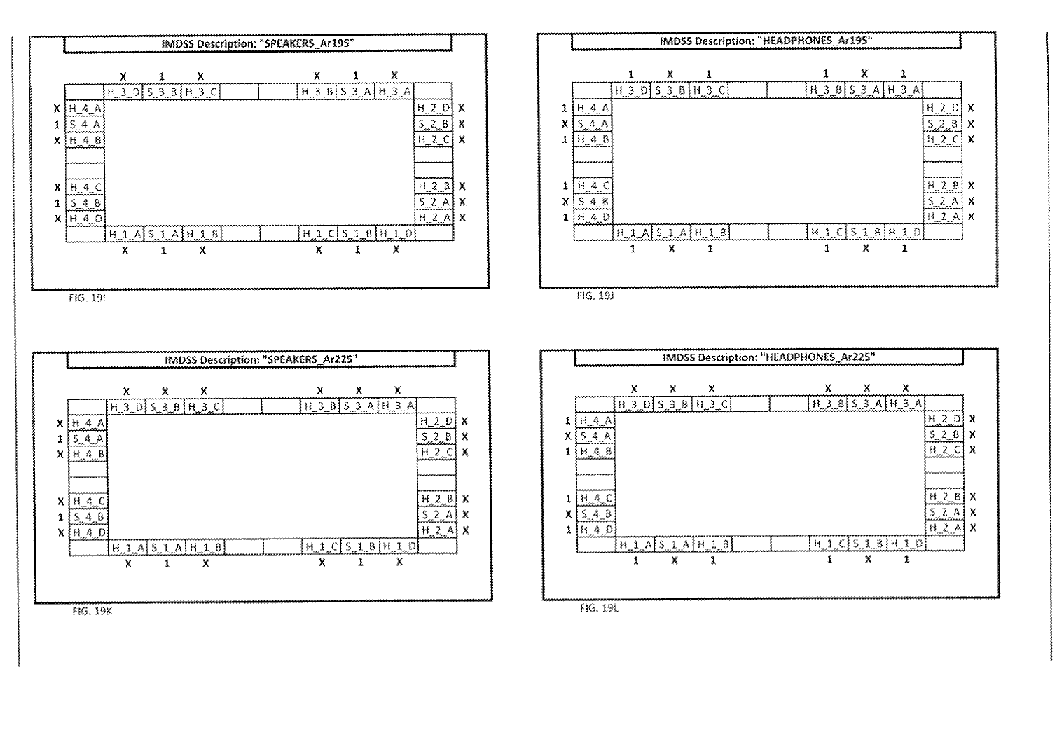

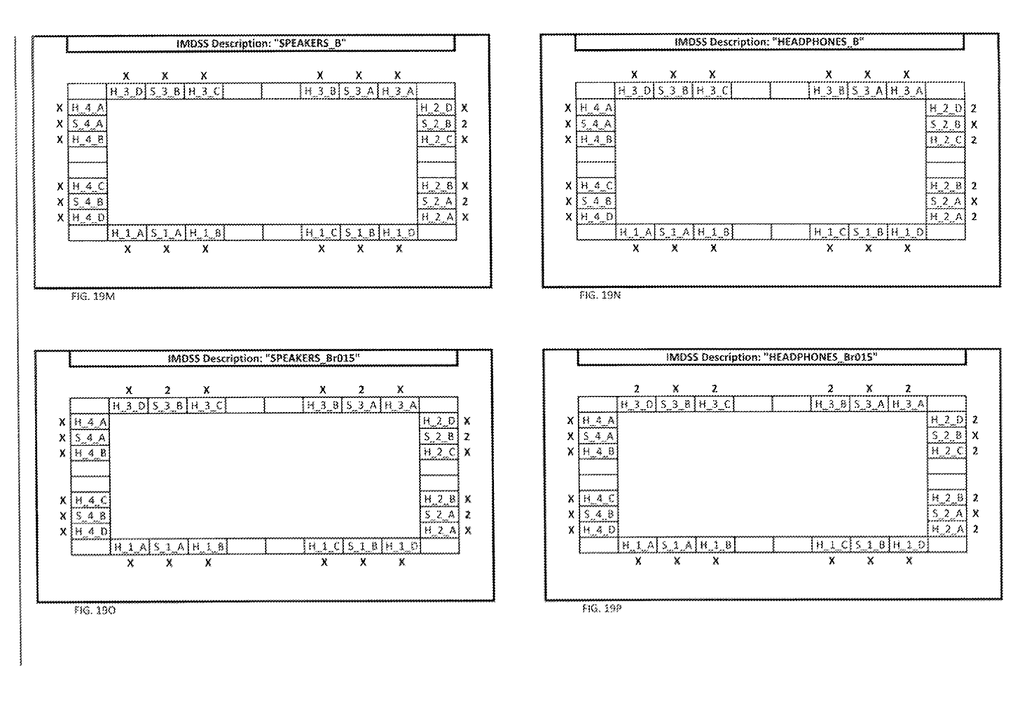

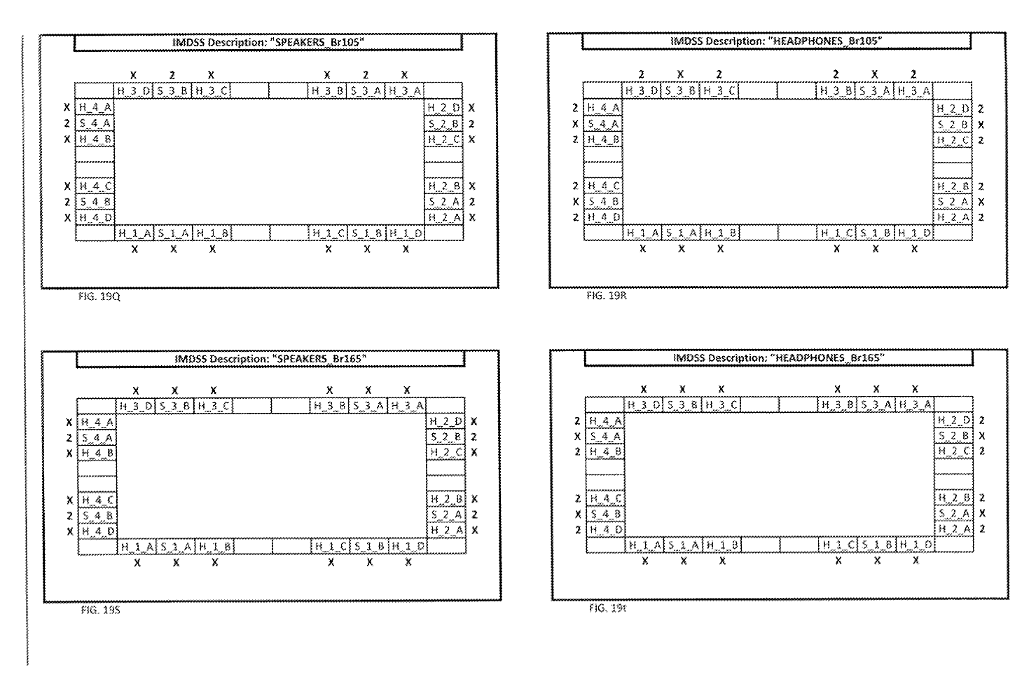

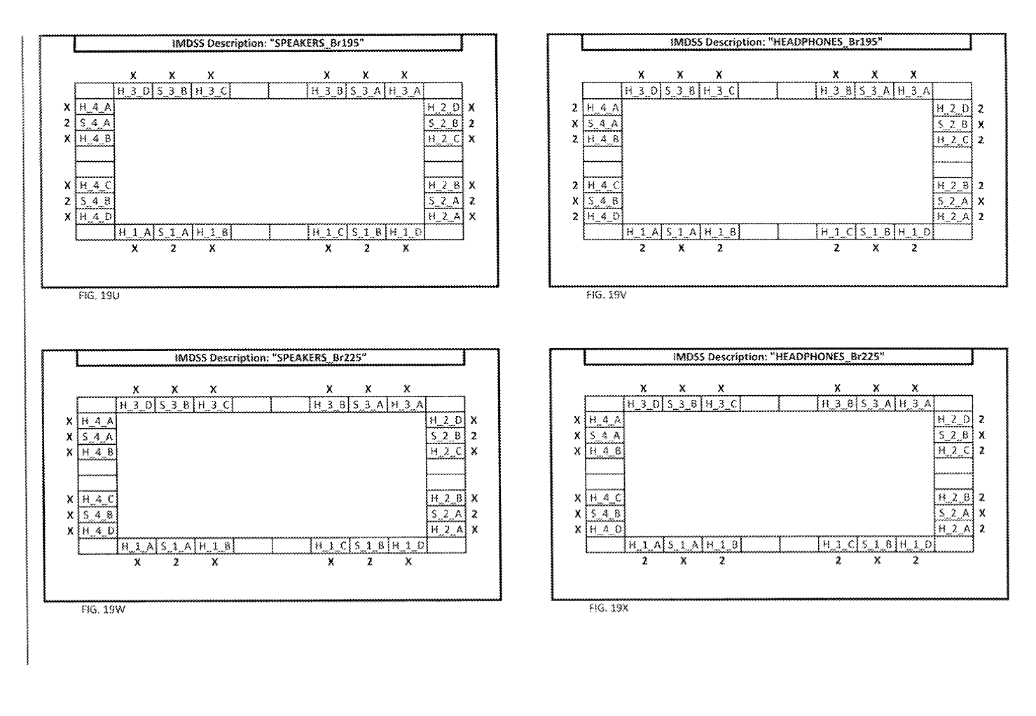

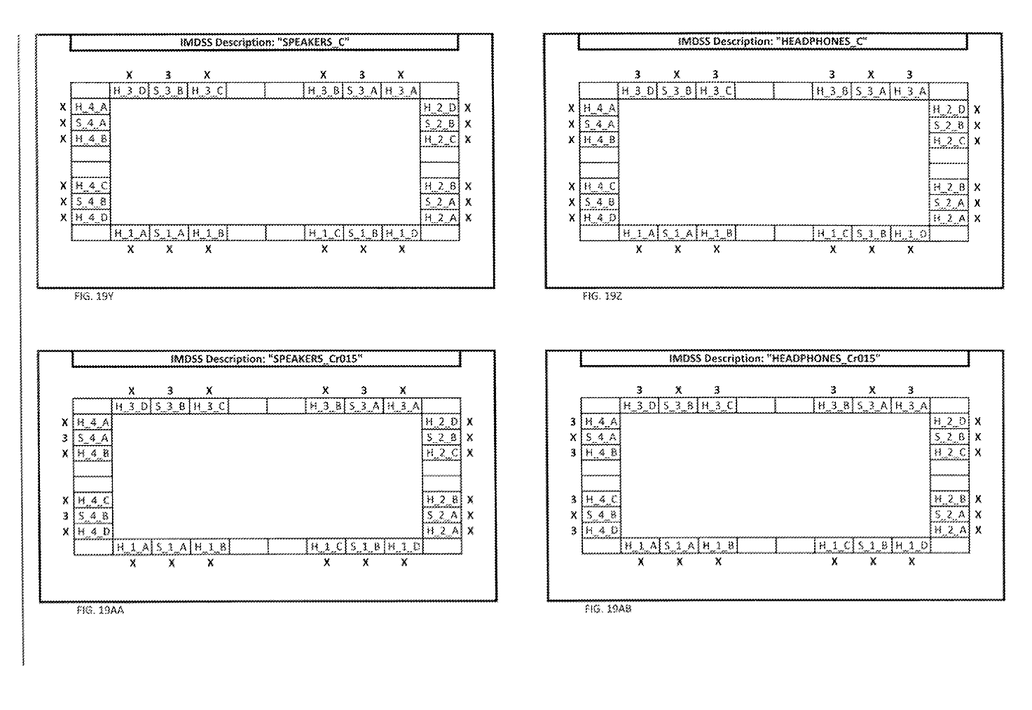

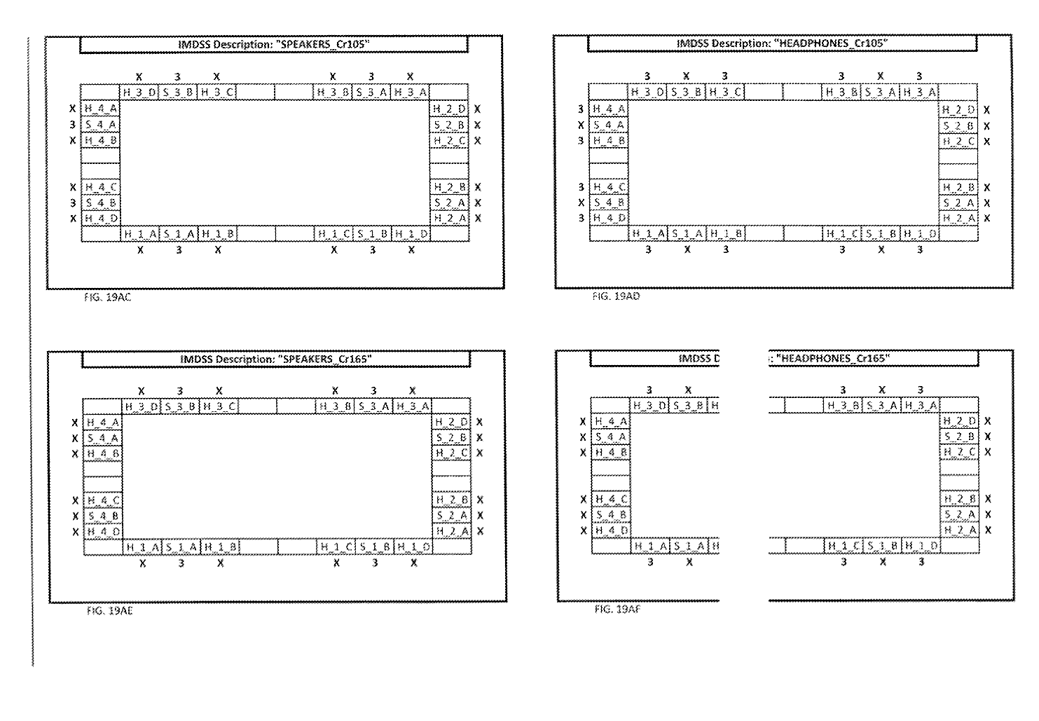

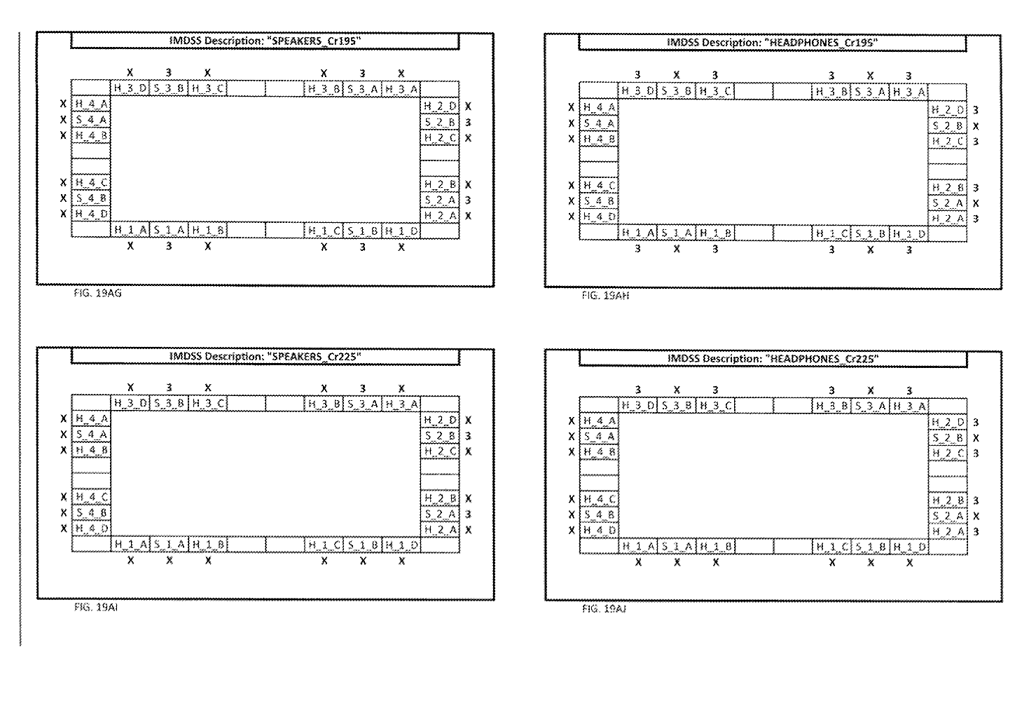

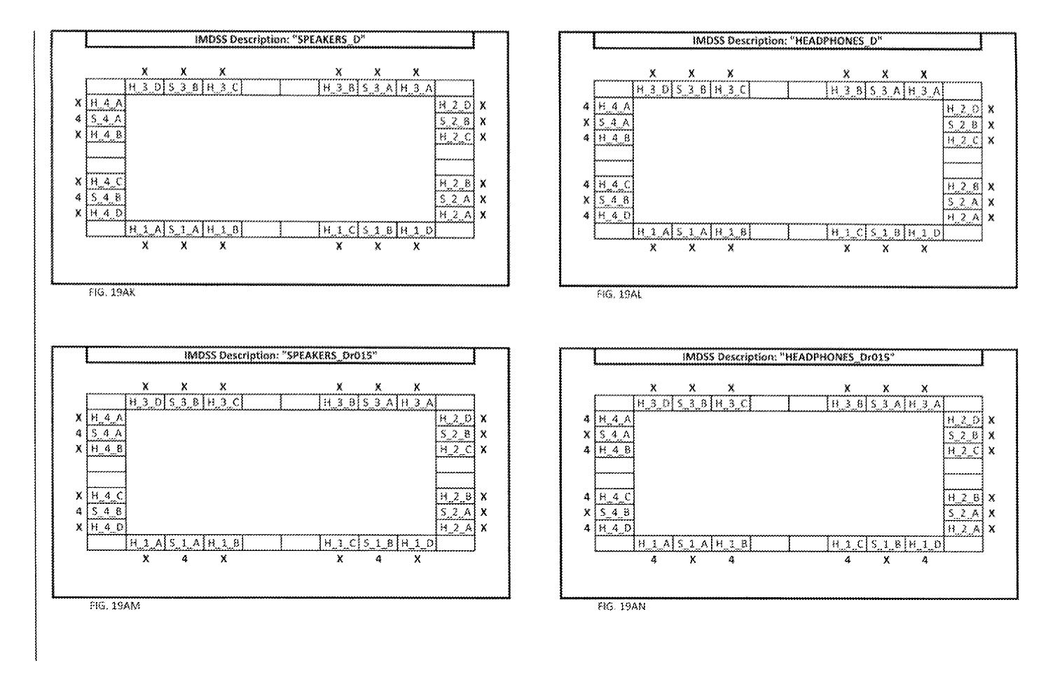

One detailed embodiment is shown in FIGS. 9A-19AV. In this embodiment, each audio device is associated with, and located on, a respective side of a four-sided table and includes 4 speakers and 2 audio jacks. The available modes are described therein. An active device in each respective mode is indicated by a number, “1”, “2”, “3”, or “4” that refers to a display area as a source of audio or an “X”, if inactive. Embodiments of the present invention thus benefit users and society as a whole by facilitating efficient transmission, display and manipulation of content from multiple sources, such as free to air, cable and satellite television signals. Embodiments of the present invention as described herein also provide enhanced user experiences and more social interactions, thus encouraging users to visit a venue in which an embodiment of the present invention is installed, stay longer in the venue and therefore spend more money in the venue, thus contributing to the economic benefit of the venue and of each country in which the invention is implemented.

We claim:

1. A table, comprising;
a touchscreen display on a surface of the table for displaying at least one content, at least one of the at least one contents displayed facing in a first direction;
a periphery including a plurality of audio devices, at least one of which is on the side or position of the table representing the first direction, and at least one of which is on a side or position of the table representing a second direction;
wherein the table is configured to output audio related to at least one of the at least one contents through the at least one audio device on the side or position of the table representing the first direction.

2. The table of claim 1, wherein the content on the touchscreen display is rotated so that it is facing the second direction, and wherein the table is configured to, in response to the rotation, increase the volume of output audio related to the content through the at least one audio device on the side or position facing the second direction.

3. The table of claim 2, wherein the table is configured to, in response to the rotation, reduce the volume of audio output related to the content through the at least one audio device on the side or position of the table representing the first direction.

4. The table of claim 1, wherein each of the audio devices not on the side or position of the table representing the first direction do not output audio related to the at least one of the at least one contents for which the table is configured to output audio.

5. The table of claim 1, wherein the display displays a plurality of contents facing in a plurality of directions;
wherein the table is configured to output audio related to a plurality of contents displayed on the table facing in a plurality of directions, for each content outputting audio through at least one audio device on the side or position of the table representing the direction that content is facing.

6. The table of claim 1, wherein the table is configured with a user interface, and wherein a user may configure the table to output audio relating to a content displayed on the table facing in a first direction using each of the plurality of audio devices on the periphery of the able.

7. The table of claim 1, wherein the display displays a plurality of contents;
wherein the table is configured to output audio related to a plurality of contents displayed on the table, for each content outputting audio through at least one audio device on the side or position of the table representing the first direction, and
wherein the audio devices along the periphery of the table on the sides or positions of the table not representing the first direction are configured to not output any audio.

8. The table of claim 1, wherein the display displays a plurality of contents, and wherein the display position of at least two of the plurality of the contents displayed on the table is switched.

9. The table of claim 1, wherein the table includes a user interface, and wherein a user rotates the display facing of at least one of the at least one contents.

10. The table of claim 1, wherein the table includes a user interface, and wherein the display position and facing of at least one of the at least one contents is locked to a single position and facing.

11. The table of claim 1, wherein the table includes a user interface and wherein at least one of the at least one contents is an interactive content.

12. The table of claim 11, wherein the display displays a plurality of contents,
wherein at least one content is an interactive content;
wherein at least one content is a non-interactive content;
wherein at least one interactive content is displayed overlaying at least one non-interactive content; and
wherein the at least one non-interactive content is visible under the interactive content.

13. The table of claim 1, wherein the audio output devices are at least one of speakers, audio jacks, or Bluetooth transmitters.
